(19) United States
(12) Patent Application Publication
(10) Pub. No.: US 2026/0281524 A1
(43) Pub. Date: Sep. 17, 2026

(54) IMAGE SENSOR STIFFENER, LENS MOUNT, AND REMOVABLE LENS COVER

(71) Applicant: GoPro, Inc., San Mateo, CA (US)

(72) Inventor: Ian Copeland Griggs, San Francisco, CA (US)

(21) Appl. No.: 19/078,950

(22) Filed: Mar. 13, 2025

(51) Int. Cl. H04N 23/52; G03B 17/14; H04N 23/51; H04N 23/54; H04N 23/55

(52) U.S. Cl. CPC H04N 23/52; G03B 17/14; H04N 23/51; H04N 23/54; H04N 23/55

(57) ABSTRACT

An image capture apparatus that includes a housing defining a cavity therein and an image capture device extending through the housing. The image capture device is at least partially disposed in the cavity of the housing. The image capture device includes a printed circuit board assembly, a stiffener coupled to a surface of the printed circuit board assembly, and an image sensor coupled to the stiffener. The stiffener is configured to prevent warpage of the printed circuit board assembly.

### TECHNICAL FIELD

This disclosure relates to an optical system, and more specifically, to an image capture device that includes a lens mount and a stiffener for the image sensor of the image capture device.

### BACKGROUND

Image capture apparatuses are used in a variety of applications. For example, image capture apparatuses may be a handheld camera or video recorder, or the image capture apparatuses may be part of (e.g., integrated into) a cell phone, drone, vehicle, the like, or a combination thereof. Such image capture apparatuses may typically include one or more lenses (or other such optical elements) and one or more image sensors, which may form or be part of image capture devices that are part of the image capture apparatuses. The lenses may capture content by receiving and focusing light, and the image sensors may convert the captured content into an electronic image signal that can be processed by an image signal processor within the image capture apparatus to generate an image. In addition to lenses and image sensors, the image capture apparatuses may include an array of internal components, both structural and electrical.

### SUMMARY

In one implementation, an image capture apparatus is disclosed. The image capture apparatus includes a housing defining a cavity therein and an image capture device extending through the housing. The image capture device is at least partially disposed in the cavity of the housing. The image capture device includes a printed circuit board assembly, a stiffener coupled to the printed circuit board assembly, and an image sensor coupled to the stiffener. The stiffener is configured to prevent warpage of the printed circuit board assembly.

In some configurations, the image sensor and the printed circuit board assembly may be free of direct contact.

In some configurations, the image sensor and the printed circuit board assembly may be in electrical communication with each other through the stiffener. The stiffener may define a slot and wiring may extend through the slot between an electrical contact of the image sensor and an electrical contact of the printed circuit board assembly.

In some configurations, the stiffener may be located between the printed circuit board assembly and the image sensor. The image sensor may be positioned outboard with respect to printed circuit board assembly toward an exterior of the housing and along an optical axis of the image capture device.

In some configurations, the image capture device may further include a sensor housing that is coupled to the stiffener. The image sensor may be disposed within a cavity defined by the sensor housing. The sensor housing may define an opening. A sensor glass may be disposed over the opening such that a field of view of the image sensor remains unobstructed by the sensor housing.

In some configurations, an outer perimeter of the stiffener may be contained within an outer perimeter of the printed circuit board assembly.

In some configurations, the image capture device may further include a lens mount coupled to a surface of the printed circuit board assembly and a lens barrel at least partially disposed within and coupled to the lens mount. The lens barrel and the image sensor may be aligned along an optical axis of the image capture device.

In some configurations, the stiffener may be coupled to a first surface of the printed circuit board assembly. The image capture device may further include a shield coupled to an opposing second surface of the printed circuit board assembly.

In another implementation, an image capture apparatus is disclosed. The image capture apparatus includes a housing defining a cavity therein and an image capture device. The image capture device includes a printed circuit board assembly located within the cavity of the housing and an image sensor assembly. The image sensor assembly includes a stiffener coupled to a surface of the printed circuit board assembly, a sensor housing coupled to a surface of the stiffener, and an image sensor located within the sensor housing and coupled to the surface of the stiffener. The image sensor is in electrical communication with the printed circuit board assembly through the stiffener.

In some configurations, the stiffener may define a slot, and wiring may extend through the slot between the image sensor and the printed circuit board assembly to establish electrical communication therebetween.

In some configurations, the stiffener may be configured to prevent warpage of the printed circuit board assembly that is caused by moisture or heat.

In some configurations, the image capture device may further include a lens barrel that is indirectly coupled to the stiffener and axially aligned with the image sensor along an optical axis of the image capture device. The lens barrel may be at least partially disposed within a lens mount. The lens mount may be coupled to the surface of the stiffener.

In another implementation, an image capture device is disclosed. The image capture device includes a printed circuit board assembly, an image sensor assembly, a lens mount coupled to a surface of the printed circuit board assembly, and a lens barrel at least partially disposed within and coupled to the lens mount. The image sensor assembly includes a stiffener coupled to the surface of the printed circuit board assembly, a sensor housing coupled to a surface of the stiffener, and an image sensor located within the sensor housing and coupled to the surface of the stiffener. The lens barrel and the image sensor are axially aligned along an optical axis of the image capture device.

In some configurations, the stiffener may be configured to prevent warpage of the printed circuit board assembly. The image sensor may be in electrical communication with the printed circuit board assembly through the stiffener.

In some configurations, the image capture device may further comprise one or more lenses disposed within the lens barrel. The one or more lenses may be axially aligned with the image sensor along the optical axis.

In some configurations, the image sensor assembly may be contained within the lens mount.

### BRIEF DESCRIPTION OF THE DRAWINGS

The disclosure is best understood from the following detailed description when read in conjunction with the accompanying drawings. It is emphasized that, according to common practice, the various features of the drawings are not to-scale. On the contrary, the dimensions of the various features are arbitrarily expanded or reduced for clarity.

FIGS. 1A-1B are isometric views of an example of an image capture apparatus.

FIGS. 2A-2B are isometric views of another example of an image capture apparatus.

FIG. 3 is a top view of another example of an image capture apparatus.

FIGS. 4A-4B are isometric views of another example of an image capture apparatus.

FIG. 5 is a block diagram of electronic components of an image capture apparatus.

FIG. 6 is an isometric view of an image capture device.

FIG. 7 is a cross-sectional view of the image capture device shown in FIG. 6 taken along line 7-7.

FIG. 8A is an isometric view of an image sensor assembly of the image capture device shown in FIG. 6.

FIG. 8B is another isometric view of the image sensor assembly shown in FIG. 8A with a sensor housing removed.

FIG. 9 is a close-up perspective view of the image sensor shown in FIG. 8B.

FIG. 10 is an isometric view of a stiffener of the image sensor assembly shown in FIG. 8A.

FIG. 11 is a cross-sectional view of another example of an image capture device.

FIG. 12 is a close-up view of the image capture device shown in FIG. 11.

FIG. 13 is an isometric view of another example of an image capture device.

FIG. 14 is a cross-sectional view of the image capture device shown in FIG. 13 taken along line 14-14.

FIG. 15 is an isometric view of another example of an image capture device.

FIG. 16 is a cross-sectional view of the image capture device shown in FIG. 15 taken along line 16-16.

### DETAILED DESCRIPTION

Image capture apparatuses may include an image capture device disposed therein that is configured to capture content (e.g., pictures and/or video). The image capture device may include one or more lenses that are fixed within the image capture device (e.g., internal lenses integrated with, or coupled to, a lens barrel of the image capture device) and one or more lenses that are removably and/or interchangeable (e.g., a replaceable lens cover positioned external of the lens barrel). The lenses may be aligned along an optical axis of the image capture device such that the lenses may capture content by receiving and focusing light. An image sensor may then convert the captured content into an electronic image signal that can be processed to generate an image. To facilitate such operation of the image capture device, the image capture apparatus may also include one or more power modules (e.g., a battery) to power the image capture device.

In order for images and/or videos to be accurately captured, the lenses and the image sensor may be aligned along the optical axis. The lenses and the image sensor may be subject to build tolerances that, if not followed, could cause misalignment and negatively impact capture of the images or videos. Additionally, if the image capture apparatus is accidentally dropped or impacted, the lenses and the image sensor may be damaged or may become misaligned, thereby negatively impacting the capture of the images or the videos.

Moreover, use of the image capture apparatus may result in increased operating temperatures, which may also negatively impact the performance of the image sensor and/or the image capture device as a whole. In an example, the image sensor may be coupled to a printed circuit board assembly (PCBA), and increased operating temperatures of the image capture device may in turn increase a temperature of the PCBA. As a result of the increased temperature, the PCBA may warp or otherwise be distorted, which could cause focus shift of the image sensor, thereby misaligning the image sensor and the lenses of the image capture device. Similarly, moisture (e.g., humidity, rain, etc.) may penetrate a housing of the image capture apparatus and reach the PCBA, which may also cause the PCBA to warp or otherwise be distorted, thereby further causing focus shift of the image sensor. Thus, increased operating temperatures and humidity may negatively impact the capture of the images of the videos.

An image capture apparatus and an image capture device are described herein that achieve and/or maintain proper alignment between the lens and the image sensor of the image capture device so that images and/or videos captured are clear and complete without distortion. Additionally, the image capture apparatus and/or the image capture device may provide improved heat resistance to maintain heightened operating temperatures of the image capture apparatus without PCBA warpage and/or distortion. Furthermore, the image capture apparatus and/or the image capture device may provide improved moisture resistance to protect internal components of the image capture device from such moisture.

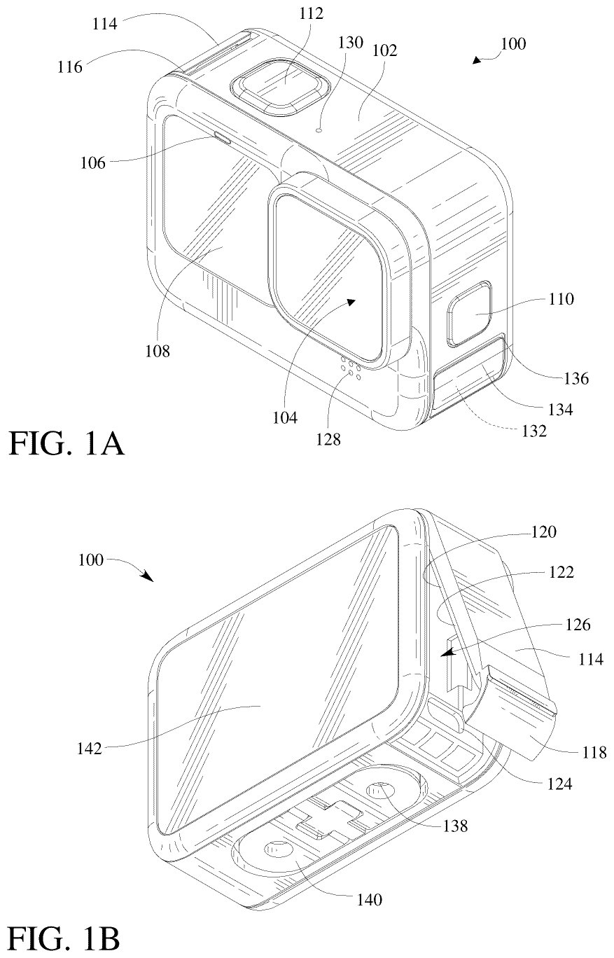

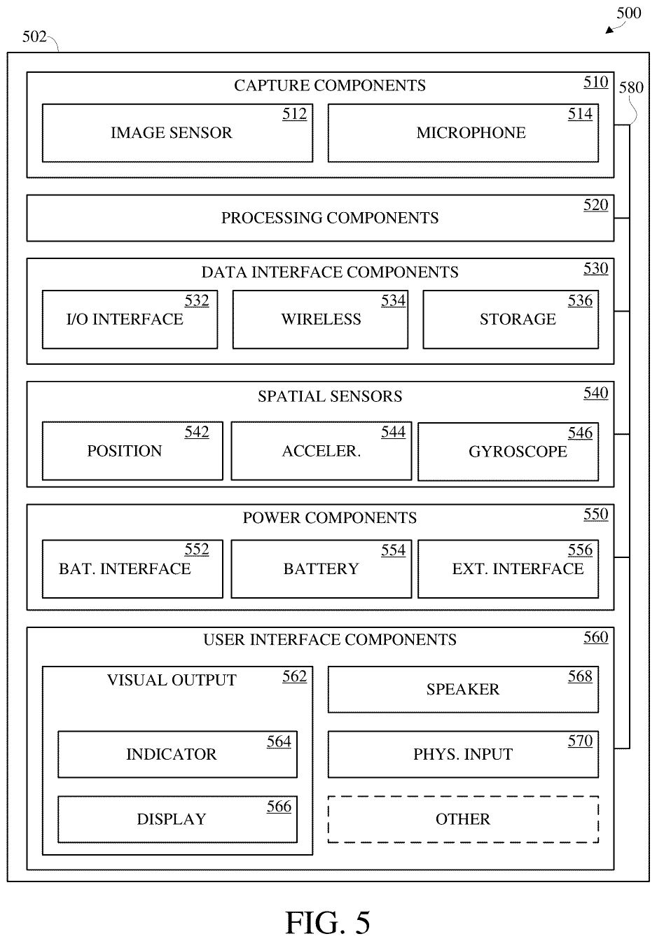

FIGS. 1A-1B are isometric views of an example of an image capture apparatus 100. The image capture apparatus 100 includes a body 102, an image capture device 104, an indicator 106, a display 108, a mode button 110, a shutter button 112, a door 114, a hinge mechanism 116, a latch mechanism 118, a seal 120, a battery interface 122, a data interface 124, a battery receptacle 126, microphones 128, 130, 132, a speaker 138, an interconnect mechanism 140, and a display 142. Although not expressly shown in FIGS. 1A-1B, the image capture apparatus 100 includes internal electronics, such as imaging electronics, power electronics, and the like, internal to the body 102 for capturing images and performing other functions of the image capture apparatus 100. An example showing internal electronics is shown in FIG. 5. The arrangement of the components of the image capture apparatus 100 shown in FIGS. 1A-1B is an example, other arrangements of elements may be used, except as is described herein or as is otherwise clear from context.

The body 102 of the image capture apparatus 100 may be made of a rigid material such as plastic, aluminum, steel, or fiberglass. Other materials may be used. The image capture device 104 is structured on a front surface of, and within, the body 102. The image capture device 104 includes a lens. The lens of the image capture device 104 receives light incident upon the lens of the image capture device 104 and directs the received light onto an image sensor of the image capture device 104 internal to the body 102. The image capture apparatus 100 may capture one or more images, such as a sequence of images, such as video. The image capture apparatus 100 may store the captured images and video for subsequent display, playback, or transfer to an external device. Although one image capture device 104 is shown in FIG. 1A, the image capture apparatus 100 may include multiple image capture devices, which may be structured on respective surfaces of the body 102.

As shown in FIG. 1A, the image capture apparatus 100 includes the indicator 106 structured on the front surface of the body 102. The indicator 106 may output, or emit, visible light, such as to indicate a status of the image capture apparatus 100. For example, the indicator 106 may be a light-emitting diode (LED). Although one indicator 106 is shown in FIG. 1A, the image capture apparatus 100 may include multiple indictors structured on respective surfaces of the body 102.

As shown in FIG. 1A, the image capture apparatus 100 includes the display 108 structured on the front surface of the body 102. The display 108 outputs, such as presents or displays, such as by emitting visible light, information, such as to show image information such as image previews, live video capture, or status information such as battery life, camera mode, elapsed time, and the like. In some implementations, the display 108 may be an interactive display, which may receive, detect, or capture input, such as user input representing user interaction with the image capture apparatus 100. In some implementations, the display 108 may be omitted or combined with another component of the image capture apparatus 100.

As shown in FIG. 1A, the image capture apparatus 100 includes the mode button 110 structured on a side surface of the body 102. Although described as a button, the mode button 110 may be another type of input device, such as a switch, a toggle, a slider, or a dial. Although one mode button 110 is shown in FIG. 1A, the image capture apparatus 100 may include multiple mode, or configuration, buttons structured on respective surfaces of the body 102. In some implementations, the mode button 110 may be omitted or combined with another component of the image capture apparatus 100. For example, the display 108 may be an interactive, such as touchscreen, display, and the mode button 110 may be physically omitted and functionally combined with the display 108.

As shown in FIG. 1A, the image capture apparatus 100 includes the shutter button 112 structured on a top surface of the body 102. The shutter button 112 may be another type of input device, such as a switch, a toggle, a slider, or a dial. The image capture apparatus 100 may include multiple shutter buttons structured on respective surfaces of the body 102. In some implementations, the shutter button 112 may be omitted or combined with another component of the image capture apparatus 100.

The mode button 110, the shutter button 112, or both, obtain input data, such as user input data in accordance with user interaction with the image capture apparatus 100. For example, the mode button 110, the shutter button 112, or both, may be used to turn the image capture apparatus 100 on and off, scroll through modes and settings, and select modes and change settings.

As shown in FIG. 1B, the image capture apparatus 100 includes the door 114 coupled to the body 102, such as using the hinge mechanism 116 (FIG. 1A). The door 114 may be secured to the body 102 using the latch mechanism 118 that releasably engages the body 102 at a position generally opposite the hinge mechanism 116. The door 114 includes the seal 120 and the battery interface 122. Although one door 114 is shown in FIG. 1A, the image capture apparatus 100 may include multiple doors respectively forming respective surfaces of the body 102, or portions thereof. The door 114 may be removable from the body 102 by releasing the latch mechanism 118 from the body 102 and decoupling the hinge mechanism 116 from the body 102.

In FIG. 1B, the door 114 is shown in a partially open position such that the data interface 124 is accessible for communicating with external devices and the battery receptacle 126 is accessible for placement or replacement of a battery. In FIG. 1A, the door 114 is shown in a closed position. In implementations in which the door 114 is in the closed position, the seal 120 engages a flange (not shown) to provide an environmental seal and the battery interface 122 engages the battery (not shown) to secure the battery in the battery receptacle 126.

As shown in FIG. 1B, the image capture apparatus 100 includes the battery receptacle 126 structured to form a portion of an interior surface of the body 102. The battery receptacle 126 includes operative connections for power transfer between the battery and the image capture apparatus 100. In some implementations, the battery receptacle 126 may be omitted. The image capture apparatus 100 may include multiple battery receptacles.

As shown in FIG. 1A, the image capture apparatus 100 includes a first microphone 128 structured on a front surface of the body 102, a second microphone 130 structured on a top surface of the body 102, and a third microphone 132 structured on a side surface of the body 102. The third microphone 132, which may be referred to as a drain microphone and is indicated as hidden in dotted line, is located behind a drain cover 134, surrounded by a drain channel 136, and can drain liquid from audio components of the image capture apparatus 100. The image capture apparatus 100 may include other microphones on other surfaces of the body 102. The microphones 128, 130, 132 receive and record audio, such as in conjunction with capturing video or separate from capturing video. In some implementations, one or more of the microphones 128, 130, 132 may be omitted or combined with other components of the image capture apparatus 100.

As shown in FIG. 1B, the image capture apparatus 100 includes the speaker 138 structured on a bottom surface of the body 102. The speaker 138 outputs or presents audio, such as by playing back recorded audio or emitting sounds associated with notifications. The image capture apparatus 100 may include multiple speakers structured on respective surfaces of the body 102.

As shown in FIG. 1B, the image capture apparatus 100 includes the interconnect mechanism 140 structured on a bottom surface of the body 102. The interconnect mechanism 140 removably connects the image capture apparatus 100 to an external structure, such as a handle grip, another mount, or a securing device. The interconnect mechanism 140 includes folding protrusions configured to move between a nested or collapsed position as shown in FIG. 1B and an extended or open position. The folding protrusions of the interconnect mechanism 140 in the extended or open position may be coupled to reciprocal protrusions of other devices such as handle grips, mounts, clips, or like devices. The image capture apparatus 100 may include multiple interconnect mechanisms structured on, or forming a portion of, respective surfaces of the body 102. In some implementations, the interconnect mechanism 140 may be omitted.

As shown in FIG. 1B, the image capture apparatus 100 includes the display 142 structured on, and forming a portion of, a rear surface of the body 102. The display 142 outputs, such as presents or displays, such as by emitting visible light, data, such as to show image information such as image previews, live video capture, or status information such as battery life, camera mode, elapsed time, and the like. In some implementations, the display 142 may be an interactive display, which may receive, detect, or capture input, such as user input representing user interaction with the image capture apparatus 100. The image capture apparatus 100 may include multiple displays structured on respective surfaces of the body 102, such as the displays 108, 142 shown in FIGS. 1A-1B. In some implementations, the display 142 may be omitted or combined with another component of the image capture apparatus 100.

The image capture apparatus 100 may include features or components other than those described herein, such as other buttons or interface features. In some implementations, interchangeable lenses, cold shoes, and hot shoes, or a combination thereof, may be coupled to or combined with the image capture apparatus 100. For example, the image capture apparatus 100 may communicate with an external device, such as an external user interface device, via a wired or wireless computing communication link, such as via the data interface 124. The computing communication link may be a direct computing communication link or an indirect computing communication link, such as a link including another device or a network, such as the Internet. The image capture apparatus 100 may transmit images to the external device via the computing communication link.

The external device may store, process, display, or combination thereof, the images. The external user interface device may be a computing device, such as a smartphone, a tablet computer, a smart watch, a portable computer, personal computing device, or another device or combination of devices configured to receive user input, communicate information with the image capture apparatus 100 via the computing communication link, or receive user input and communicate information with the image capture apparatus 100 via the computing communication link. The external user interface device may implement or execute one or more applications to manage or control the image capture apparatus 100. For example, the external user interface device may include an application for controlling camera configuration, video acquisition, video display, or any other configurable or controllable aspect of the image capture apparatus 100. In some implementations, the external user interface device may generate and share, such as via a cloud-based or social media service, one or more images or video clips. In some implementations, the external user interface device may display unprocessed or minimally processed images or video captured by the image capture apparatus 100 contemporaneously with capturing the images or video by the image capture apparatus 100, such as for shot framing or live preview.

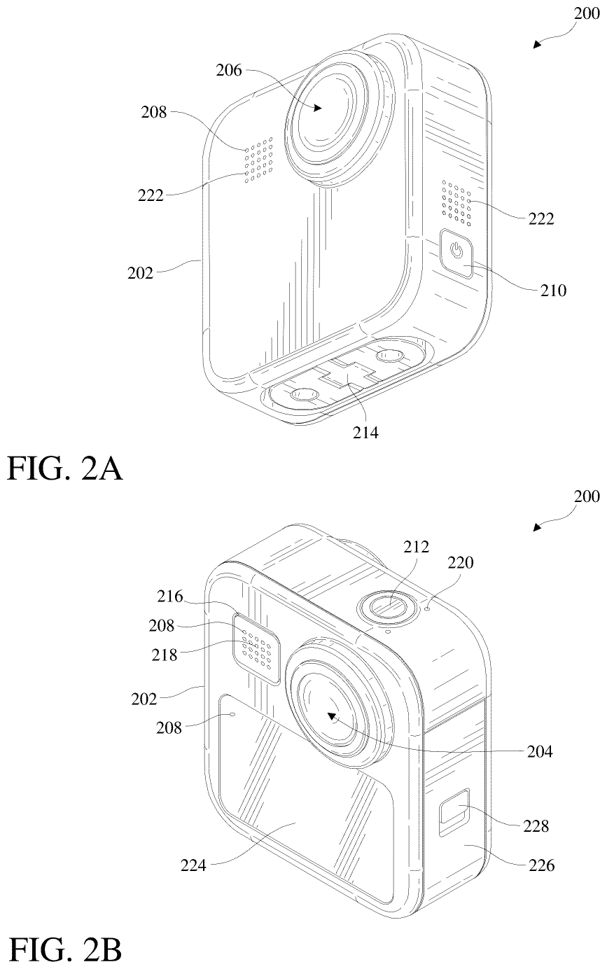

FIGS. 2A-2B illustrate another example of an image capture apparatus 200. The image capture apparatus 200 is similar to the image capture apparatus 100 shown in FIGS. 1A-1B. The image capture apparatus 200 includes a body 202, a first image capture device 204, a second image capture device 206, indicators 208, a mode button 210, a shutter button 212, an interconnect mechanism 214, a drainage channel 216, audio components 218, 220, 222, a display 224, and a door 226 including a release mechanism 228. The arrangement of the components of the image capture apparatus 200 shown in FIGS. 2A-2B is an example, other arrangements of elements may be used.

The body 202 of the image capture apparatus 200 may be similar to the body 102 shown in FIGS. 1A-1B. The first image capture device 204 is structured on a front surface of the body 202. The first image capture device 204 includes a first lens. The first image capture device 204 may be similar to the image capture device 104 shown in FIG. 1A. As shown in FIG. 2A, the image capture apparatus 200 includes the second image capture device 206 structured on a rear surface of the body 202. The second image capture device 206 includes a second lens. The second image capture device 206 may be similar to the image capture device 104 shown in FIG. 1A. The image capture devices 204, 206 are disposed on opposing surfaces of the body 202, for example, in a back-to-back configuration, Janus configuration, or offset Janus configuration. The image capture apparatus 200 may include other image capture devices structured on respective surfaces of the body 202.

As shown in FIG. 2B, the image capture apparatus 200 includes the indicators 208 associated with the audio component 218 and the display 224 on the front surface of the body 202. The indicators 208 may be similar to the indicator 106 shown in FIG. 1A. For example, one of the indicators 208 may indicate a status of the first image capture device 204 and another one of the indicators 208 may indicate a status of the second image capture device 206. Although two indicators 208 are shown in FIGS. 2A-2B, the image capture apparatus 200 may include other indictors structured on respective surfaces of the body 202.

As shown in FIGS. 2A-2B, the image capture apparatus 200 includes input mechanisms including the mode button 210, structured on a side surface of the body 202, and the shutter button 212, structured on a top surface of the body 202. The mode button 210 may be similar to the mode button 110 shown in FIG. 1B. The shutter button 212 may be similar to the shutter button 112 shown in FIG. 1A.

The image capture apparatus 200 includes internal electronics (not expressly shown), such as imaging electronics, power electronics, and the like, internal to the body 202 for capturing images and performing other functions of the image capture apparatus 200. An example showing internal electronics is shown in FIG. 5.

As shown in FIGS. 2A-2B, the image capture apparatus 200 includes the interconnect mechanism 214 structured on a bottom surface of the body 202. The interconnect mechanism 214 may be similar to the interconnect mechanism 140 shown in FIG. 1B.

As shown in FIG. 2B, the image capture apparatus 200 includes the drainage channel 216 for draining liquid from audio components of the image capture apparatus 200.

As shown in FIGS. 2A-2B, the image capture apparatus 200 includes the audio components 218, 220, 222, respectively structured on respective surfaces of the body 202. The audio components 218, 220, 222 may be similar to the microphones 128, 130, 132 and the speaker 138 shown in FIGS. 1A-1B. One or more of the audio components 218, 220, 222 may be, or may include, audio sensors, such as microphones, to receive and record audio signals, such as voice commands or other audio, in conjunction with capturing images or video. One or more of the audio components 218, 220, 222 may be, or may include, an audio presentation component that may present, or play, audio, such as to provide notifications or alerts.

As shown in FIGS. 2A-2B, a first audio component 218 is located on a front surface of the body 202, a second audio component 220 is located on a top surface of the body 202, and a third audio component 222 is located on a back surface of the body 202. Other numbers and configurations for the audio components 218, 220, 222 may be used. For example, the audio component 218 may be a drain microphone surrounded by the drainage channel 216 and adjacent to one of the indicators 208 as shown in FIG. 2B.

As shown in FIG. 2B, the image capture apparatus 200 includes the display 224 structured on a front surface of the body 202. The display 224 may be similar to the displays 108, 142 shown in FIGS. 1A-1B. The display 224 may include an I/O interface. The display 224 may include one or more of the indicators 208. The display 224 may receive touch inputs. The display 224 may display image information during video capture. The display 224 may provide status information to a user, such as status information indicating battery power level, memory card capacity, time elapsed for a recorded video, etc. The image capture apparatus 200 may include multiple displays structured on respective surfaces of the body 202. In some implementations, the display 224 may be omitted or combined with another component of the image capture apparatus 200.

As shown in FIG. 2B, the image capture apparatus 200 includes the door 226 structured on, or forming a portion of, the side surface of the body 202. The door 226 may be similar to the door 114 shown in FIG. 1A. For example, the door 226 shown in FIG. 2A includes a release mechanism 228. The release mechanism 228 may include a latch, a button, or other mechanism configured to receive a user input that allows the door 226 to change position. The release mechanism 228 may be used to open the door 226 for a user to access a battery, a battery receptacle, an I/O interface, a memory card interface, etc.

In some embodiments, the image capture apparatus 200 may include features or components other than those described herein, some features or components described herein may be omitted, or some features or components described herein may be combined. For example, the image capture apparatus 200 may include additional interfaces or different interface features, interchangeable lenses, cold shoes, or hot shoes.

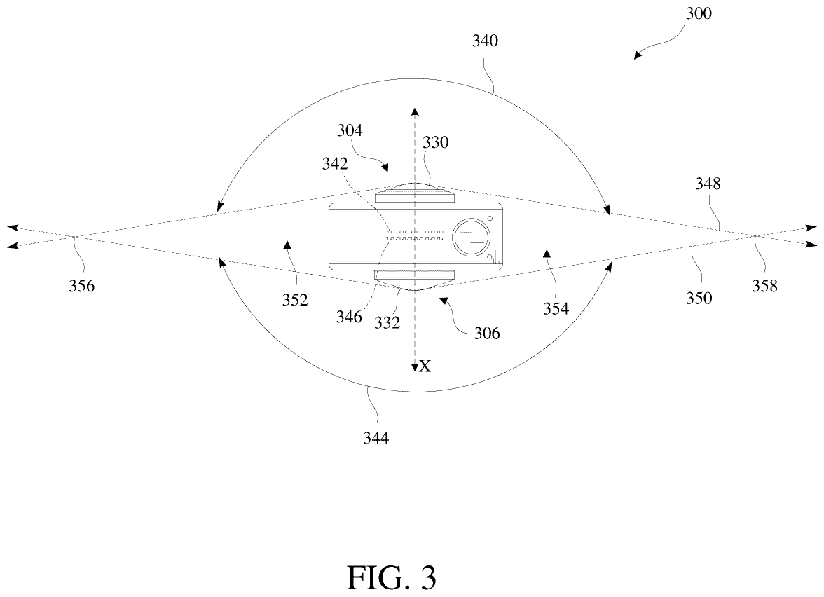

FIG. 3 is a top view of an image capture apparatus 300. The image capture apparatus 300 is similar to the image capture apparatus 200 of FIGS. 2A-2B and is configured to capture spherical images.

As shown in FIG. 3, a first image capture device 304 includes a first lens 330 and a second image capture device 306 includes a second lens 332. For example, the first image capture device 304 may capture a first image, such as a first hemispheric, or hyper-hemispherical, image, the second image capture device 306 may capture a second image, such as a second hemispheric, or hyper-hemispherical, image, and the image capture apparatus 300 may generate a spherical image incorporating or combining the first image and the second image, which may be captured concurrently, or substantially concurrently.

The first image capture device 304 defines a first field-of-view 340 wherein the first lens 330 of the first image capture device 304 receives light. The first lens 330 directs the received light corresponding to the first field-of-view 340 onto a first image sensor 342 of the first image capture device 304. For example, the first image capture device 304 may include a first lens barrel (not expressly shown), extending from the first lens 330 to the first image sensor 342.

The second image capture device 306 defines a second field-of-view 344 wherein the second lens 332 receives light. The second lens 332 directs the received light corresponding to the second field-of-view 344 onto a second image sensor 346 of the second image capture device 306. For example, the second image capture device 306 may include a second lens barrel (not expressly shown), extending from the second lens 332 to the second image sensor 346.

A boundary 348 of the first field-of-view 340 is shown using broken directional lines. A boundary 350 of the second field-of-view 344 is shown using broken directional lines. As shown, the image capture devices 304, 306 are arranged in a back-to-back (Janus) configuration such that the lenses 330, 332 face in opposite directions, and such that the image capture apparatus 300 may capture spherical images. The first image sensor 342 captures a first hyper-hemispherical image plane from light entering the first lens 330. The second image sensor 346 captures a second hyper-hemispherical image plane from light entering the second lens 332.

As shown in FIG. 3, the fields-of-view 340, 344 partially overlap such that the combination of the fields-of-view 340, 344 forms a spherical field-of-view, except that one or more uncaptured areas 352, 354 may be outside of the fields-of-view 340, 344 of the lenses 330, 332. Light emanating from or passing through the uncaptured areas 352, 354, which may be proximal to the image capture apparatus 300, may be obscured from the lenses 330, 332 and the corresponding image sensors 342, 346, such that content corresponding to the uncaptured areas 352, 354 may be omitted from images captured by the image capture apparatus 300. In some implementations, the image capture devices 304, 306, or the lenses 330, 332 thereof, may be configured to minimize the uncaptured areas 352, 354.

Examples of points of transition, or overlap points, from the uncaptured areas 352, 354 to the overlapping portions of the fields-of-view 340, 344 are shown at 356, 358.

Images contemporaneously captured by the respective image sensors 342, 346 may be combined to form a combined image, such as a spherical image. Generating a combined image may include correlating the overlapping regions captured by the respective image sensors 342, 346, aligning the captured fields-of-view 340, 344, and stitching the images together to form a cohesive combined image. Stitching the images together may include correlating the overlap points 356, 358 with respective locations in corresponding images captured by the image sensors 342, 346. Although a planar view of the fields-of-view 340, 344 is shown in FIG. 3, the fields-of-view 340, 344 are hyper-hemispherical.

A change in the alignment, such as position, tilt, or a combination thereof, of the image capture devices 304, 306, such as of the lenses 330, 332, the image sensors 342, 346, or both, may change the relative positions of the respective fields-of-view 340, 344, may change the locations of the overlap points 356, 358, such as with respect to images captured by the image sensors 342, 346, and may change the uncaptured areas 352, 354, which may include changing the uncaptured areas 352, 354 unequally.

Incomplete or inaccurate information indicating the alignment of the image capture devices 304, 306, such as the locations of the overlap points 356, 358, may decrease the accuracy, efficiency, or both of generating a combined image. In some implementations, the image capture apparatus 300 may maintain information indicating the location and orientation of the image capture devices 304, 306, such as of the lenses 330, 332, the image sensors 342, 346, or both, such that the fields-of-view 340, 344, the overlap points 356, 358, or both may be accurately determined, which may improve the accuracy, efficiency, or both of generating a combined image.

The lenses 330, 332 may be aligned along an axis X as shown, laterally offset from each other (not shown), off-center from a central axis of the image capture apparatus 300 (not shown), or laterally offset and off-center from the central axis (not shown). Whether through use of offset or through use of compact image capture devices 304, 306, a reduction in distance between the lenses 330, 332 along the axis X may improve the overlap in the fields-of-view 340, 344, such as by reducing the uncaptured areas 352, 354.

Images or frames captured by the image capture devices 304, 306 may be combined, merged, or stitched together to produce a combined image, such as a spherical or panoramic image, which may be an equirectangular planar image. In some implementations, generating a combined image may include use of techniques such as noise reduction, tone mapping, white balancing, or other image correction. In some implementations, pixels along a stitch boundary, which may correspond with the overlap points 356, 358, may be matched accurately to minimize boundary discontinuities.

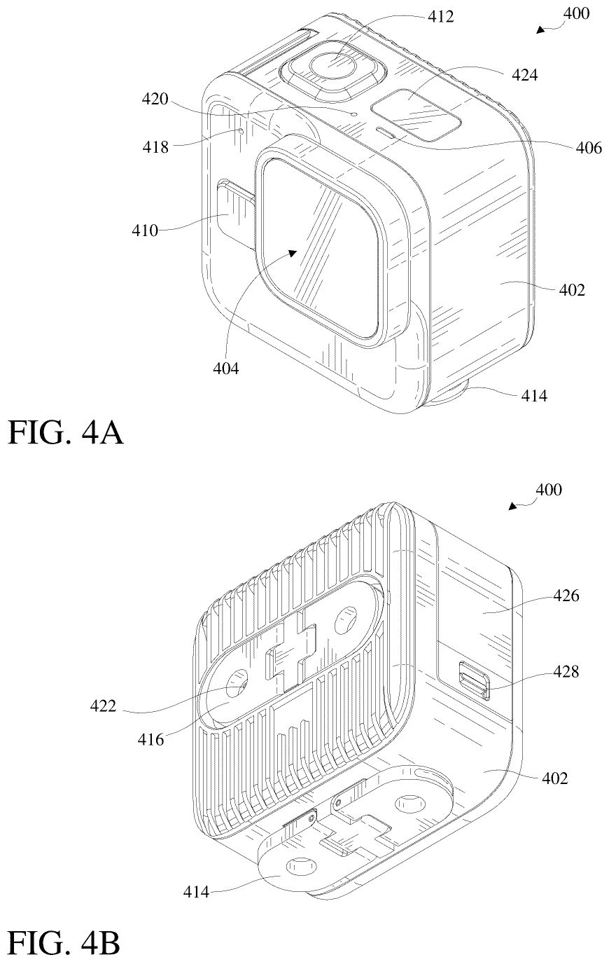

FIGS. 4A-4B illustrate another example of an image capture apparatus 400. The image capture apparatus 400 is similar to the image capture apparatus 100 shown in FIGS. 1A-1B and to the image capture apparatus 200 shown in FIGS. 2A-2B. The image capture apparatus 400 includes a body 402, an image capture device 404, an indicator 406, a mode button 410, a shutter button 412, interconnect mechanisms 414, 416, audio components 418, 420, 422, a display 424, and a door 426 including a release mechanism 428. The arrangement of the components of the image capture apparatus 400 shown in FIGS. 4A-4B is an example, other arrangements of elements may be used.

The body 402 of the image capture apparatus 400 may be similar to the body 102 shown in FIGS. 1A-1B. The image capture device 404 is structured on a front surface of the body 402. The image capture device 404 includes a lens and may be similar to the image capture device 104 shown in FIG. 1A.

As shown in FIG. 4A, the image capture apparatus 400 includes the indicator 406 on a top surface of the body 402. The indicator 406 may be similar to the indicator 106 shown in FIG. 1A. The indicator 406 may indicate a status of the image capture device 204. Although one indicator 406 is shown in FIG. 4A, the image capture apparatus 400 may include other indictors structured on respective surfaces of the body 402.

As shown in FIG. 4A, the image capture apparatus 400 includes input mechanisms including the mode button 410, structured on a front surface of the body 402, and the shutter button 412, structured on a top surface of the body 402. The mode button 410 may be similar to the mode button 110 shown in FIG. 1B. The shutter button 412 may be similar to the shutter button 112 shown in FIG. 1A.

The image capture apparatus 400 includes internal electronics (not expressly shown), such as imaging electronics, power electronics, and the like, internal to the body 402 for capturing images and performing other functions of the image capture apparatus 400. An example showing internal electronics is shown in FIG. 5.

As shown in FIGS. 4A-4B, the image capture apparatus 400 includes the interconnect mechanisms 414, 416, with a first interconnect mechanism 414 structured on a bottom surface of the body 402 and a second interconnect mechanism 416 disposed within a rear surface of the body 402. The interconnect mechanisms 414, 416 may be similar to the interconnect mechanism 140 shown in FIG. 1B and the interconnect mechanism 214 shown in FIG. 2A.

As shown in FIGS. 4A-4B, the image capture apparatus 400 includes the audio components 418, 420, 422 respectively structured on respective surfaces of the body 402. The audio components 418, 420, 422 may be similar to the microphones 128, 130, 132 and the speaker 138 shown in FIGS. 1A-1B. One or more of the audio components 418, 420, 422 may be, or may include, audio sensors, such as microphones, to receive and record audio signals, such as voice commands or other audio, in conjunction with capturing images or video. One or more of the audio components 418, 420, 422 may be, or may include, an audio presentation component that may present, or play, audio, such as to provide notifications or alerts.

As shown in FIGS. 4A-4B, a first audio component 418 is located on a front surface of the body 402, a second audio component 420 is located on a top surface of the body 402, and a third audio component 422 is located on a rear surface of the body 402. Other numbers and configurations for the audio components 418, 420, 422 may be used.

As shown in FIG. 4A, the image capture apparatus 400 includes the display 424 structured on a front surface of the body 402. The display 424 may be similar to the displays 108, 142 shown in FIGS. 1A-1B. The display 424 may include an I/O interface. The display 424 may receive touch inputs. The display 424 may display image information during video capture. The display 424 may provide status information to a user, such as status information indicating battery power level, memory card capacity, time elapsed for a recorded video, etc. The image capture apparatus 400 may include multiple displays structured on respective surfaces of the body 402. In some implementations, the display 424 may be omitted or combined with another component of the image capture apparatus 200.

As shown in FIG. 4B, the image capture apparatus 400 includes the door 426 structured on, or forming a portion of, the side surface of the body 402. The door 426 may be similar to the door 226 shown in FIG. 2B. The door 426 shown in FIG. 4B includes the release mechanism 428. The release mechanism 428 may include a latch, a button, or other mechanism configured to receive a user input that allows the door 426 to change position. The release mechanism 428 may be used to open the door 426 for a user to access a battery, a battery receptacle, an I/O interface, a memory card interface, etc.

In some embodiments, the image capture apparatus 400 may include features or components other than those described herein, some features or components described herein may be omitted, or some features or components described herein may be combined. For example, the image capture apparatus 400 may include additional interfaces or different interface features, interchangeable lenses, cold shoes, or hot shoes.

FIG. 5 is a block diagram of electronic components in an image capture apparatus 500. The image capture apparatus 500 may be a single-lens image capture device, a multi-lens image capture device, or variations thereof, including an image capture apparatus with multiple capabilities such as the use of interchangeable integrated sensor lens assemblies. Components, such as electronic components, of the image capture apparatus 100 shown in FIGS. 1A-1B, the image capture apparatus 200 shown in FIGS. 2A-2B, the image capture apparatus 300 shown in FIG. 3, or the image capture apparatus 400 shown in FIGS. 4A-4B, may be implemented as shown in FIG. 5.

The image capture apparatus 500 includes a body 502. The body 502 may be similar to the body 102 shown in FIGS. 1A-1B, the body 202 shown in FIGS. 2A-2B, or the body 402 shown in FIGS. 4A-4B. The body 502 includes electronic components such as capture components 510, processing components 520, data interface components 530, spatial sensors 540, power components 550, user interface components 560, and a bus 580.

The capture components 510 include an image sensor 512 for capturing images. Although one image sensor 512 is shown in FIG. 5, the capture components 510 may include multiple image sensors. The image sensor 512 may be similar to the image sensors 342, 346 shown in FIG. 3. The image sensor 512 may be, for example, a charge-coupled device (CCD) sensor, an active pixel sensor (APS), a complementary metal-oxide-semiconductor (CMOS) sensor, or an N-type metal-oxide-semiconductor (NMOS) sensor. The image sensor 512 detects light, such as within a defined spectrum, such as the visible light spectrum or the infrared spectrum, incident through a corresponding lens such as the first lens 330 with respect to the first image sensor 342 or the second lens 332 with respect to the second image sensor 346 as shown in FIG. 3. The image sensor 512 captures detected light as image data and conveys the captured image data as electrical signals (image signals or image data) to the other components of the image capture apparatus 500, such as to the processing components 520, such as via the bus 580.

The capture components 510 include a microphone 514 for capturing audio. Although one microphone 514 is shown in FIG. 5, the capture components 510 may include multiple microphones. The microphone 514 detects and captures, or records, sound, such as sound waves incident upon the microphone 514. The microphone 514 may detect, capture, or record sound in conjunction with capturing images by the image sensor 512. The microphone 514 may detect sound to receive audible commands to control the image capture apparatus 500. The microphone 514 may be similar to the microphones 128, 130, 132 shown in FIGS. 1A-1B, the audio components 218, 220, 222 shown in FIGS. 2A-2B, or the audio components 418, 420, 422 shown in FIGS. 4A-4B.

The processing components 520 perform image signal processing, such as filtering, tone mapping, or stitching, to generate, or obtain, processed images, or processed image data, based on image data obtained from the image sensor 512. The processing components 520 may include one or more processors having single or multiple processing cores. In some implementations, the processing components 520 may include, or may be, an application specific integrated circuit (ASIC) or a digital signal processor (DSP). For example, the processing components 520 may include a custom image signal processor. The processing components 520 conveys data, such as processed image data, with other components of the image capture apparatus 500 via the bus 580. In some implementations, the processing components 520 may include an encoder, such as an image or video encoder that may encode, decode, or both, the image data, such as for compression coding, transcoding, or a combination thereof.

Although not shown expressly in FIG. 5, the processing components 520 may include memory, such as a random-access memory (RAM) device, which may be non-transitory computer-readable memory. The memory of the processing components 520 may include executable instructions and data that can be accessed by the processing components 520.

The data interface components 530 communicates with other, such as external, electronic devices, such as a remote control, a smartphone, a tablet computer, a laptop computer, a desktop computer, or an external computer storage device. For example, the data interface components 530 may receive commands to operate the image capture apparatus 500. In another example, the data interface components 530 may transmit image data to transfer the image data to other electronic devices. The data interface components 530 may be configured for wired communication, wireless communication, or both. As shown, the data interface components 530 include an I/O interface 532, a wireless data interface 534, and a storage interface 536. In some implementations, one or more of the I/O interface 532, the wireless data interface 534, or the storage interface 536 may be omitted or combined.

The I/O interface 532 may send, receive, or both, wired electronic communications signals. For example, the I/O interface 532 may be a universal serial bus (USB) interface, such as USB type-C interface, a high-definition multimedia interface (HDMI), a FireWire interface, a digital video interface link, a display port interface link, a Video Electronics Standards Associated (VESA) digital display interface link, an Ethernet link, or a Thunderbolt link. Although one I/O interface 532 is shown in FIG. 5, the data interface components 530 include multiple I/O interfaces. The I/O interface 532 may be similar to the data interface 124 shown in FIG. 1B.

The wireless data interface 534 may send, receive, or both, wireless electronic communications signals. The wireless data interface 534 may be a Bluetooth interface, a ZigBee interface, a Wi-Fi interface, an infrared link, a cellular link, a near field communications (NFC) link, or an Advanced Network Technology interoperability (ANT+) link. Although one wireless data interface 534 is shown in FIG. 5, the data interface components 530 include multiple wireless data interfaces. The wireless data interface 534 may be similar to the data interface 124 shown in FIG. 1B.

The storage interface 536 may include a memory card connector, such as a memory card receptacle, configured to receive and operatively couple to a removable storage device, such as a memory card, and to transfer, such as read, write, or both, data between the image capture apparatus 500 and the memory card, such as for storing images, recorded audio, or both captured by the image capture apparatus 500 on the memory card. Although one storage interface 536 is shown in FIG. 5, the data interface components 530 include multiple storage interfaces. The storage interface 536 may be similar to the data interface 124 shown in FIG. 1B.

The spatial, or spatiotemporal, sensors 540 detect the spatial position, movement, or both, of the image capture apparatus 500. As shown in FIG. 5, the spatial sensors 540 include a position sensor 542, an accelerometer 544, and a gyroscope 546. The position sensor 542, which may be a global positioning system (GPS) sensor, may determine a geospatial position of the image capture apparatus 500, which may include obtaining, such as by receiving, temporal data, such as via a GPS signal. The accelerometer 544, which may be a three-axis accelerometer, may measure linear motion, linear acceleration, or both of the image capture apparatus 500. The gyroscope 546, which may be a three-axis gyroscope, may measure rotational motion, such as a rate of rotation, of the image capture apparatus 500. In some implementations, the spatial sensors 540 may include other types of spatial sensors. In some implementations, one or more of the position sensor 542, the accelerometer 544, and the gyroscope 546 may be omitted or combined.

The power components 550 distribute electrical power to the components of the image capture apparatus 500 for operating the image capture apparatus 500. As shown in FIG. 5, the power components 550 include a battery interface 552, a battery 554, and an external power interface 556 (ext. interface). The battery interface 552 (bat. interface) operatively couples to the battery 554, such as via conductive contacts to transfer power from the battery 554 to the other electronic components of the image capture apparatus 500. The battery interface 552 may be similar to the battery receptacle 126 shown in FIG. 1B. The external power interface 556 obtains or receives power from an external source, such as a wall plug or external battery, and distributes the power to the components of the image capture apparatus 500, which may include distributing power to the battery 554 via the battery interface 552 to charge the battery 554. Although one battery interface 552, one battery 554, and one external power interface 556 are shown in FIG. 5, any number of battery interfaces, batteries, and external power interfaces may be used. In some implementations, one or more of the battery interface 552, the battery 554, and the external power interface 556 may be omitted or combined. For example, in some implementations, the external interface 556 and the I/O interface 532 may be combined.

The user interface components 560 receive input, such as user input, from a user of the image capture apparatus 500, output, such as display or present, information to a user, or both receive input and output information, such as in accordance with user interaction with the image capture apparatus 500.

As shown in FIG. 5, the user interface components 560 include visual output components 562 to visually communicate information, such as to present captured images. As shown, the visual output components 562 include an indicator 564 and a display 566. The indicator 564 may be similar to the indicator 106 shown in FIG. 1A, the indicators 208 shown in FIGS. 2A-2B, or the indicator 406 shown in FIG. 4A. The display 566 may be similar to the display 108 shown in FIG. 1A, the display 142 shown in FIG. 1B, the display 224 shown in FIG. 2B, or the display 424 shown in FIG. 4A. Although the visual output components 562 are shown in FIG. 5 as including one indicator 564, the visual output components 562 may include multiple indicators. Although the visual output components 562 are shown in FIG. 5 as including one display 566, the visual output components 562 may include multiple displays. In some implementations, one or more of the indicator 564 or the display 566 may be omitted or combined.

As shown in FIG. 5, the user interface components 560 include a speaker 568. The speaker 568 may be similar to the speaker 138 shown in FIG. 1B, the audio components 218, 220, 222 shown in FIGS. 2A-2B, or the audio components 418, 420, 422 shown in FIGS. 4A-4B. Although one speaker 568 is shown in FIG. 5, the user interface components 560 may include multiple speakers. In some implementations, the speaker 568 may be omitted or combined with another component of the image capture apparatus 500, such as the microphone 514.

As shown in FIG. 5, the user interface components 560 include a physical input interface 570. The physical input interface 570 may be similar to the mode buttons 110, 210, 410 shown in FIGS. 1A, 2A, and 4A or the shutter buttons 112, 212, 412 shown in FIGS. 1A, 2B, and 4A. Although one physical input interface 570 is shown in FIG. 5, the user interface components 560 may include multiple physical input interfaces. In some implementations, the physical input interface 570 may be omitted or combined with another component of the image capture apparatus 500. The physical input interface 570 may be, for example, a button, a toggle, a switch, a dial, or a slider.

As shown in FIG. 5, the user interface components 560 include a broken line border box labeled “other” to indicate that components of the image capture apparatus 500 other than the components expressly shown as included in the user interface components 560 may be user interface components. For example, the microphone 514 may receive, or capture, and process audio signals to obtain input data, such as user input data corresponding to voice commands. In another example, the image sensor 512 may receive, or capture, and process image data to obtain input data, such as user input data corresponding to visible gesture commands. In another example, one or more of the spatial sensors 540, such as a combination of the accelerometer 544 and the gyroscope 546, may receive, or capture, and process motion data to obtain input data, such as user input data corresponding to motion gesture commands.

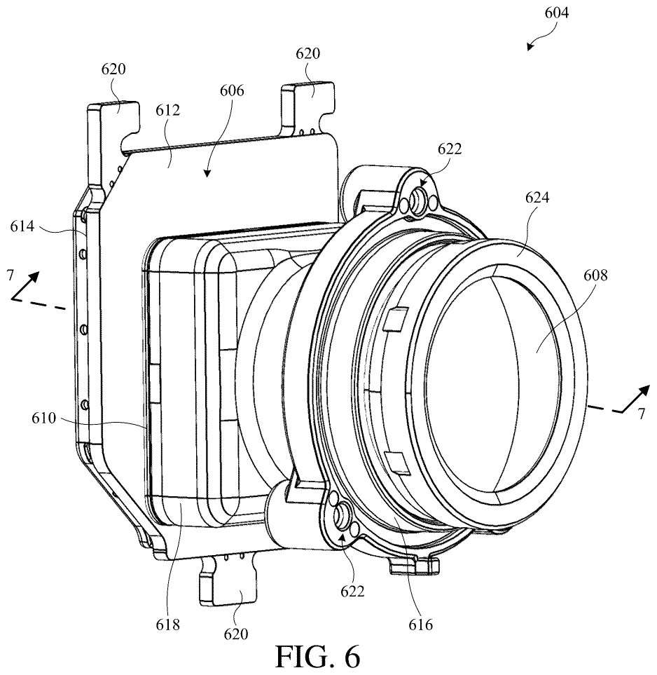

FIG. 6 is an isometric view of another example of an image capture device 604. The image capture device 604 may be similar to the image capture devices 104, 204, 206, 304, 306, 404 described above. The image capture device 604 may be part of an image capture apparatus, such as the image capture apparatus 100, 200, 300, 400 described above. In an example, the image capture device 604 may be at least partially disposed within a housing of an image capture apparatus and may extend through the housing. For example, the image capture device 604 may be at least partially disposed within the body 402 (i.e., a housing) of the image capture apparatus 400 shown in FIGS. 4A and 4B. However, the image capture device 604 is not particularly limited to any one image capture apparatus or housing thereof.

The image capture device 604 includes a printed circuit board assembly (PCBA) 606. As discussed further below, the PCBA 606 may be in communication with an image sensor of the image capture device 604 to capture images and/or video (for simplicity, hereinafter referred to broadly as “images”) via the image sensor. Moreover, the PCBA 606 may be configured to process the captured the images. For example, the PCBA 606 may include a processor (e.g., an image signal processor (ISP)), which may receive the captured images (e.g., captured image data) and perform one or more operations to enhance the captured images. In an example, the processor may perform operations to reduce noise in the images (e.g., to eliminate unwanted artifacts in the images), to correct color of the images, to sharpen and/or enhance the images, to balance the color of the images, to adjust brightness of the image, or a combination thereof.

The PCBA 606 may also include memory to at least temporarily store the captured images (e.g., the captured image data) during processing by the processor of the PCBA 606. In addition the PCBA 606 controlling capturing and/or processing of images, the PCBA 606 may control one or more operations of the image capture device 604. For example, the microprocessor of the PCBA 606 may further control: zoom functionality of one or more lenses of the image capture device 604, such as a first lens 608; a display screen of the image capture apparatus containing the image capture device 604; storage media connected to the image capture apparatus (e.g., memory cards, internal storage, etc.); external interfaces (e.g., external ports and/or external devices in communication with the image capture apparatus via the external ports); power management of the image capture apparatus; or a combination thereof.

The image capture device 604 may also include a stiffener 610 that is coupled to a first surface 612 of the PCBA 606. The first surface 612 may be considered an upper surface of the PCBA 606 and may be opposed by a second surface 614 that may be considered a lower surface. As shown in FIG. 6, an outer perimeter (e.g., an outer periphery) of the stiffener 610 may be substantially or entirely contained within an outer perimeter of the PCBA 606. As such, the outer perimeter of the stiffener 610 may be smaller than the outer perimeter of the PCBA 606. That is, an overall footprint of the stiffener 610 at least partially defined by the outer perimeter of the stiffener 610 may be smaller than an overall footprint of the PCBA 606 defined by the outer perimeter of the PCBA 606.

The stiffener 610 may be coupled to the PCBA 606 in any desired manner. By way of example, the stiffener 610 may be adhered to the first surface 612 of the PCBA 606, may be mechanically fastened to the PCBA 606 via one or more fasteners (e.g., screws, bolts, nails, pins, etc.), or both. Alternatively, or additionally, the stiffener 610 may be mechanically interlocked with the PCBA 606, such as via a keyhole slot or a similar configuration, to maintain coupling of the stiffener 610 to the PCBA 606. However, such mounting techniques are not limited to those described above.

The stiffener 610 may be configured to prevent warpage of the PCBA 606 caused by moisture and/or temperature fluctuations during operation of the image capture device 604. As such, the stiffener 610 may act as a reinforcement to the PCBA 606 to prevent unwanted distortion of the PCBA 606, which may ultimately cause misalignment of the image capture device 604 and negatively impact the images captured by the image capture device 604. To facilitate such reinforcement of the PCBA 606, the stiffener 610 may be entirely disposed along the first surface 612 of the PCBA 606 or may be localized to a particular region of concern of the PCBA 606. In an example, the stiffener 610 may be localized to a portion of the first surface 612 that supports, or aligns with, a lens barrel 616 of the image capture device 604. For example, as shown in FIG. 6, the image capture device 604 may include a lens mount 618 coupled to the first surface 612 of the PCBA 606 and the lens barrel 616 may be at least partially disposed within and coupled to the lens mount 618, thereby connecting the lens barrel 616 to the PCBA 606. Thus, the stiffener 610 may be locally disposed on the PCBA 606 to support the lens mount 618 and the lens barrel 616 to ensure proper alignment between the lens barrel 616 the image sensor.

To facilitate operation of the image capture device 604, the PCBA 606 may include one or more tabs, such as the tabs 620. The tabs 620 may be configured to secure the PCBA 606—and thus the image capture device 604—within the housing of the image capture apparatus to maintain a position of the image capture device 604 during operation. As discussed above, the lens mount 618 may be coupled to the first surface 612 of the PCBA 606 and the lens barrel 616 may be at least partially disposed within and coupled to the lens mount 618. As such, when the PCBA 606 is secured within the housing of the image capture apparatus via the tabs 620, a position of the lens barrel 616 may be maintained to ensure proper alignment of the lens barrel 616 with respect to the image sensor disposed on the PCBA 606. Additionally, the lens mount may include one or more mounting holes, such as the mounting holes 622, to further secure the lens mount 618 to the housing of the image capture apparatus. As a result, unwanted movement (e.g., vibration, flexing, etc.) of the lens barrel 616 may be even further prevented.

Similarly, the lens barrel 616 may include a lens ring 624 that is configured to secure the first lens 608 within the lens barrel 616. While the lens mount 618, the lens barrel 616, and the stiffener 610 may maintain a position of the lens barrel 616 relative to the PCBA 606, the lens ring 624 may maintain a position of the first lens 608 relative to the lens barrel 616, and thus also maintain a position of the first lens 608 relative to the image sensor disposed on the PCBA 606 and/or one or more internal lens located within the lens barrel 616. As such, alignment of the image capture device 604 may be maintained to ensure that the images captured by the image capture device 604 are clear and not distorted.

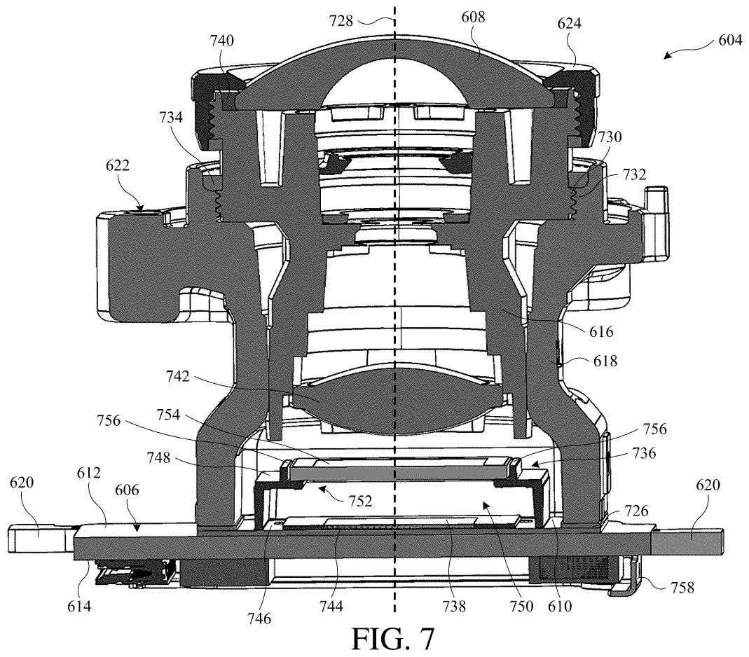

FIG. 7 illustrates a cross-sectional view of the image capture device 604 shown in FIG. 6 taken along line 7-7. As discussed above with respect to FIG. 6, the image capture device 604 may include the PCBA 606, the stiffener 610, the lens barrel 616, and the lens mount 618 coupled to one another. As such, the image capture device 604 may be at least partially disposed within and extend through a housing of an image capture apparatus, such as the image capture apparatus 100, 200, 300, 400 described above.

As shown in FIG. 7, the stiffener 610 may be disposed between the PCBA 606 and the lens mount 618 to thereby secure the lens mount 618 to the first surface 612 of the PCBA 606. In an example, the lens mount 618 may be secured to the stiffener 610 by a lens mount adhesive 726 disposed therebetween. However, the lens mount 618 may be secured in other manners, such as via one or more mechanical fasteners and/or mechanical interlocks. Moreover, while FIG. 7 illustrates that the lens mount 618 may be indirectly coupled to the first surface 612 of the PCBA 606 via the stiffener 610, in some configurations the lens mount 618 may be coupled directly to the first surface 612 of the PCBA 606. For example, the lens mount 618 may have a diameter that is great than a width of the stiffener 610, as measured transverse to an optical axis 728 of the image capture device 604, such that the lens mount 618 extends beyond the perimeter of the stiffener 610 to directly contact the first surface 612 of the PCBA 606.

The lens mount 618 may couple the lens barrel 616 to the stiffener 610, and thus also indirectly couple the lens barrel 616 to the PCBA 606 (e.g., indirectly couple the lens barrel 616 to the first surface 612 of the PCBA 606 via the stiffener 610). In particular, the lens barrel 616 may include threading 730 that is configured to engage (e.g., thread into in a complementary manner) threading 732 of the lens mount 618. As such, the lens barrel 616 may in some configurations be able to threadably release (i.e., disconnect) from the lens mount 618. Moreover, a lens barrel seal 734 (e.g., a gasket, o-ring, compressible member, etc.) may be disposed between the lens mount 618 and the lens barrel 616 adjacent to the threaded connection to prevent moisture and/or debris from penetrating therebetween. Thus, the lens barrel 616 may be replaced and/or interchangeable with other lens barrels without disconnecting the lens mount 618 from the stiffener 610.

The lens mount 618 may be coupled to the stiffener 610 to ensure proper alignment between the lens barrel 616 and an image sensor assembly 736 coupled to the PCBA 606. In particular, the lens mount 618 may be coupled to the stiffener 610 so that lens barrel 616 and an image sensor 738 of the image sensor assembly 736 may be aligned along the optical axis 728 of the image capture device 604. In an example, the first lens 608, which is secured to the lens barrel 616 via the lens ring 624 and a first lens seal 740 located therebetween, and a second lens 742 disposed within the lens barrel 616 may also be optically aligned with the image sensor 738 along the optical axis 728. As such, the image sensor 738 may capture images through the lens barrel 616 (e.g., through the first lens 608 and the second lens 742) free of distortion.

To facilitate image capturing without distortion, the image sensor assembly 736 may be coupled to the PCBA 606, either directly or indirectly. As shown in FIG. 7, the image sensor assembly 736 may be indirectly coupled to the first surface 612 of the PCBA 606 via the stiffener 610. In particular, the image sensor 738 may be coupled to the stiffener 610 to secure the image sensor 738 to the PCBA 606 and align the image sensor 738 with the lens barrel 616 along the optical axis 728. The image sensor 738 may be secured to the stiffener 610 using any fastening means, such as an image sensor adhesive 744 disposed therebetween. However, the image sensor 738 may also be secured to the stiffener 610 via one or more fasteners and/or mechanical interlocks. As such, the image sensor 738 and the PCBA 606 may be free of direct contact. That is, the stiffener 610 may be located between the PCBA 606 and the image sensor 738 such that the image sensor 738 may be positioned outboard with respect to the PCBA 606 toward an exterior of the housing of the image capture apparatus (e.g., toward the first lens 608, which may extend beyond the exterior of the housing) and along the optical axis 728 of the image capture device 604.

The stiffener 610 may help maintain the position of the image sensor 738 with respect to the lens barrel 616 (e.g., with respect to the first lens 608 and the second lens 742) along the optical axis 728. As described above with respect to FIG. 6, the stiffener 610 may be configured to prevent warpage of the PCBA 606 that may be caused by moisture and/or heat. In an example, during operation of the image capture device 604, the PCBA 606 and/or the image sensor assembly 736 (e.g., the image sensor 738) may generate heat. Additionally, environmental conditions may also exhibit significant temperature fluctuations and expose the image capture device 604 to extreme heat and/or cold. As a result, the PCBA 606 may be prone to warp or be otherwise distorted. As such, the stiffener 610 may be disposed on the PCBA 606 (e.g., on the first surface 612 of the PCBA 606) to prevent such warpage or distortion. That is, the stiffener 610 may increase the structural rigidity of the PCBA 606 so that the PCBA 606 is more resistant to warpage or distortion that may be caused by moisture and/or heat.

The stiffener 610 may also help protect the image sensor 738 from moisture and/or debris. As shown in FIG. 7, the image sensor assembly 736 may be contained within the lens mount 618 (e.g., within a cavity defined by the lens mount 618). The image sensor 738 and the lens mount 618 may be secured to the stiffener 610, such as along a surface 746 of the stiffener 610, to secure the image sensor 738 within the lens mount 618. Moreover, the image sensor assembly 736 may include a sensor housing 748 that is coupled to the stiffener 610 and/or directly coupled to the PCBA 606. As shown in FIG. 7, the sensor housing 748 may define a cavity 750, and the image sensor 738 may be disposed within the cavity 750. As such, the sensor housing 748 may further protect the image sensor 738 from damage caused by moisture and/or debris. Furthermore, the sensor housing 748 may act as a shield to protect the image sensor 738 from electrical interference.

While the sensor housing 748 may provide protection to the image sensor 738 as described above, the sensor housing 748 may also be positioned such that the image sensor 738 remains unobstructed by the sensor housing 748 when capturing images. That is, the sensor housing 748 does not obstruct the image sensor 738 when capturing images through the first lens 608 and the second lens 742. To prevent obstruction, the sensor housing 748 may define an opening 752 positioned above (e.g., outward from) the image sensor 738 along the optical axis 728 and towards an exterior surface of the image capture device 604.

A sensor glass 754 may be disposed over the opening such that a field of view of the image sensor 738 may remain unobstructed by the sensor housing 748. The sensor glass 754 may be any transparent material (e.g., glass, plastic, etc.) that may protect the image sensor 738 located within the cavity 750 of the sensor housing 748 yet does not obstruct the field of view of the image sensor 738 (e.g., the field of view of the image sensor 738 through the lens barrel 616). Moreover, to ensure that the position of the sensor glass 754 is maintained relative to the sensor housing 748, the sensor housing 748 may include one or more flanges 756 projecting from a surface of the sensor housing 748. The sensor glass 754 may be disposed between or adjacent to the flanges 756 to ensure that the sensor glass 754 maintains its position to cover the opening 752 of the sensor housing 748.

As described above with respect to FIG. 7, the image capture device 604 may provide a more robust structure compared to conventional image capture devices. That is, by utilizing the stiffener 610 located between the image sensor assembly 736 and the PCBA 606 (e.g., between the image sensor 738 and the PCBA 606), the rigidity of the PCBA 606 may be improved. As such, operation of the image capture device 604 may be improved to ensure that images captured by the image sensor 738 are not negatively impacted by warpage or distortion of the PCBA 606. Moreover, other countermeasures of the image capture device 604 may further improve operation of the image capture device 604. For example, as discussed above, the stiffener 610 may be coupled to the first surface 612 of the PCBA 606 to secure the image sensor 738 thereon and position the image sensor 738 within the sensor housing 748 to protect the image sensor 738 from electronic interference. Similarly, the image capture device 604 may further include a PCBA shield 758 coupled to the opposing second surface 614 of the PCBA 606. The PCBA shield 758 may further protect the PCBA 606 and/or the image sensor 738 from electronic interference. As such, operational integrity of the image capture device 604 (e.g., image capturing) may be maintained even when outside factors, such as environmental conditions, may potentially negatively impact the operation of the image capture device 604.

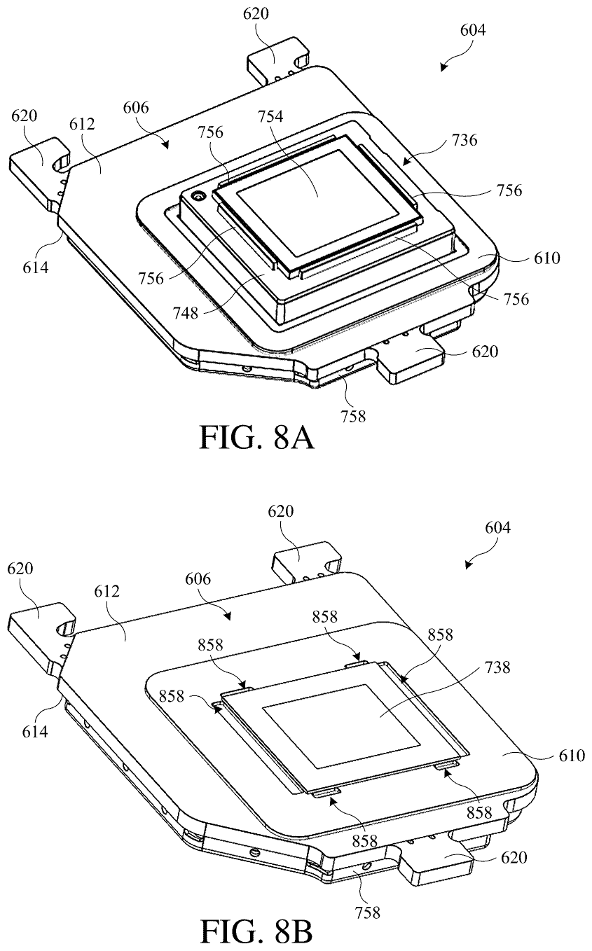

To further illustrate mounting the image sensor assembly 736 to the PCBA 606, FIGS. 8A and 8B illustrate isometric views of the image capture device 604 shown in FIG. 6. FIG. 8A illustrates the image sensor assembly 736 and the PCBA 606 with the lens mount 618 and the lens barrel 616 removed for illustrative purposes. FIG. 8B illustrates the image sensor 738 and the PCBA 606 with the sensor housing 748 and the sensor glass 754 removed for illustrative purposes.

As shown in FIGS. 8A and 8B, the image sensor assembly 736 may be coupled indirectly to the first surface 612 of the PCBA 606 via the stiffener 610. In particular, the sensor housing 748 and the image sensor 738 may be coupled to directly to the surface 746 of the stiffener 610 such that the sensor housing 748 and the image sensor 738 may be coupled to the first surface 612 of the PCBA 606. As a result, the image sensor assembly 736 may be coupled to the first surface 612 and directly oppose the PCBA shield 758, which may be coupled to the opposing second surface 614. Furthermore, to facilitate operation of the image sensor 738 (e.g., image capturing), the sensor glass 754 may be disposed over the opening 752 defined by the sensor housing 748. The sensor housing 748 may include the flanges 756, which may be positioned adjacent to one or more peripheral edges of the sensor glass 754, to align the sensor glass 754 with the sensor housing 748 (e.g., align the sensor glass 754 to cover the opening 752 of the sensor housing 748). A size and/or shape of the flanges 756 are not particularly limited, and the sensor housing 748 may include any number of the flanges 756 and/or additional alignment features (e.g., pins, bumps, fingers, etc.) to align the sensor glass 754 with the sensor housing 748.

The image sensor 738 may also be in electrical communication with the PCBA 606 so that images captured by the image sensor 738 may be communicated to the PCBA 606 for further operations (e.g., image processing, image transmittal, etc.). Similarly, based on such electrical communication, the PCBA 606 may control operation of the image sensor 738 (e.g., to capture images). As shown in FIG. 8B, the image sensor 738 and the PCBA 606 may be in electrical communication with each other through the stiffener 610.

By way of example, the stiffener 610 may define one or more slots, such as the slots 858, and wiring may extend through one or more of the slots 858 between the image sensor 738 and the PCBA 606 to establish electrical communication therebetween. Any number of the slots 858 may be present in the stiffener 610. Furthermore, the slots 858 may be positioned anywhere along the stiffener 610 to facilitate wiring the image sensor 738 to the PCBA 606. Moreover, the slots 858 may be any size and/or shape. For example, a first set of the slots 858 may be larger in size than a second set of the slots 858 and/or the first set of the slots 858 may have a different shape than the second set of the slots 858. Thus, the stiffener 610 may improve the structural integrity of the PCBA 606 while still providing a means to electrically connect the image sensor 738 to the PCBA 606.

While the sensor housing 748 may be coupled to the stiffener 610, the sensor housing 748 may also be directly coupled to the PCBA 606. For example, the sensor housing 748 may extend through one or more of the slots 858 such that the sensor housing 748 may directly contact the PCBA 606 to directly secure the sensor housing 748 to the PCBA 606. As such, the slots 858 may facilitate both electrical and mechanical connections between the image sensor assembly 736 and the PCBA 606.

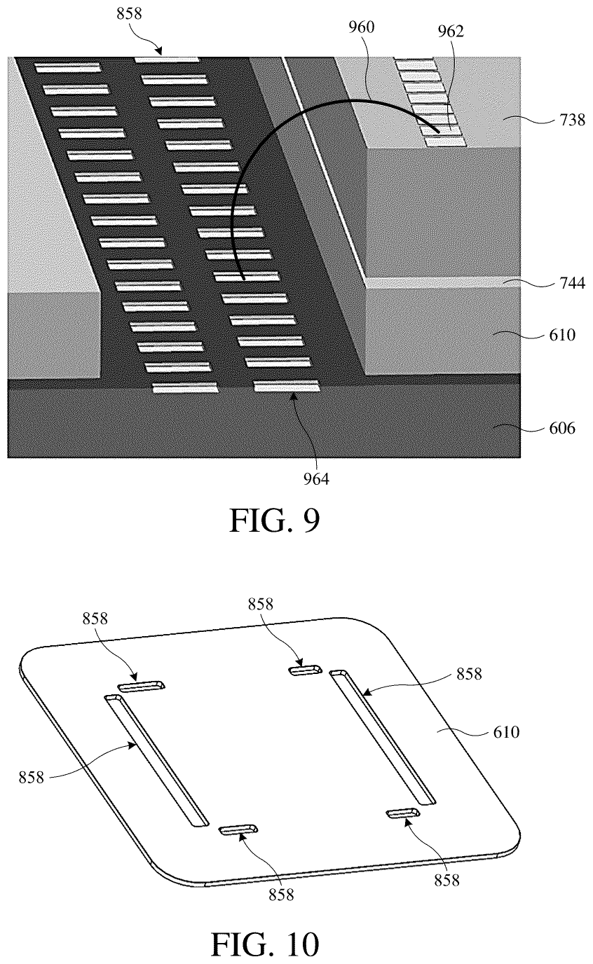

FIG. 9 illustrates a close-up view of the image sensor shown in FIG. 8B. As shown in FIG. 9, the image sensor 738 may be coupled to the stiffener 610 via the image sensor adhesive 744. Additionally, the stiffener 610 may define the slots 858 therein for electrical connection between the image sensor 738 and the PCBA 606. For example, wiring 960 may extend through at least one of the slots 858 between an electrical contact 962 of the image sensor 738 and an electrical contact 964 of the PCBA 606. Connection to the electrical contact 962 of the image sensor 738 and the electrical contact 964 of the PCBA 606 may be done in any desired manner. Moreover, the image sensor 738 and the PCBA 606 may have any number of electrical contacts to establish one or more wired connections therebetween.

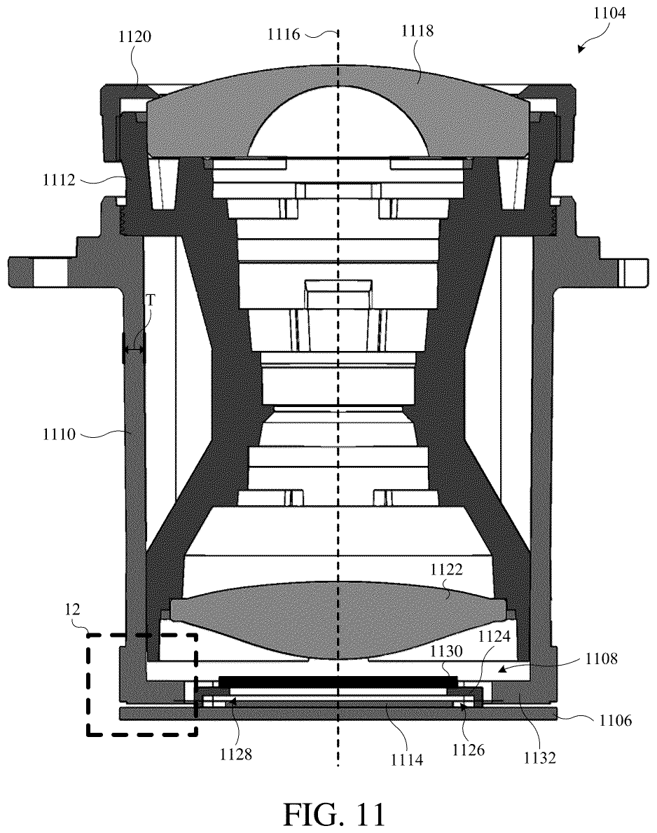

FIG. 10 illustrates an isometric view of the stiffener 610 of the image capture device 604 shown in FIGS. 6-8. As discussed above, the stiffener 610 may define the slots 858 shown in detail in FIG. 9. The slots 858 may be positioned anywhere along the stiffener 610 and may be any size and/or shape. The slots 858 may facilitate electrical connection between the image sensor 738 and the PCBA 606, as described above with respect to FIG. 9. Furthermore, in some configurations, the slots 858 may also facilitate direct connection of the sensor housing 748 to the PCBA 606 (e.g., through one or more of the slots 858). The slots 858 may be positioned along or adjacent to one or more peripheral edges of the image sensor 738. As such, the image sensor 738 may not obstruct the slots 858 and thereby permit access to the PCBA 606 through the slots 858 for wiring.

The stiffener 610 may be any thickness, size, or shape. Moreover, the stiffener 610 is not limited to any one particular material. For example, the stiffener 610 may be made from steel, titanium, aluminum, copper, ceramic, iron, other metals, polymers, or a combination thereof. The stiffener 610 may also be treated to further improve its structural integrity. For example, the stiffener 610 may be surface treated using black anodizing and/or physical vapor deposition to coat a surface of the stiffener 610 to improve resistance to corrosion, improve a hardness of the stiffener 610, improve wear resistance, or a combination thereof. Thus, the stiffener 610 may maintain its structural integrity to help prevent warpage or distortion of the PCBA 606.

FIG. 11 illustrates a cross-sectional view of another example of an image capture device 1104. The image capture device 1104 may be similar to the image capture devices 104, 204, 206, 304, 306, 404, 604 described above. The image capture device 1104 may be part of an image capture apparatus, such as the image capture apparatus 100, 200, 300, 400 described above. In an example, the image capture device 1104 may be at least partially disposed within a housing of an image capture apparatus and may extend through the housing. For example, the image capture device 1104 may be at least partially disposed within the body 402 (i.e., a housing) of the image capture apparatus 400 shown in FIGS. 4A and 4B. However, the image capture device 1104 is not particularly limited to any one image capture apparatus or housing thereof.

The image capture device 1104 may include a printed circuit board assembly (PCBA) 1106, an image sensor assembly 1108 coupled to the PCBA 1106, a lens mount 1110, and a lens barrel 1112. The lens mount 1110 may be coupled to the PCBA 1106 such that the image sensor assembly 1108 is located within the lens mount 1110 (e.g., within a cavity defined by the lens mount 1110). The lens mount 1110 may be coupled to the PCBA 1106 such that the image sensor assembly 1108 (e.g., an image sensor 1114 of the image sensor assembly 1108) is optically aligned with the lens barrel 1112. For example, the lens mount 1110 may be secured to the PCBA 1106 such that the image sensor 1114 is aligned with the lens barrel 1112 along an optical axis 1116 of the image capture device 1104. In particular, the image sensor 1114 may be axially aligned with one or more lenses of the lens barrel 1112 along the optical axis 1116, such a first lens 1118 secured to the lens barrel 1112 via a lens ring 1120 and/or a second lens 1122 disposed within the lens barrel 1112.

As shown in FIG. 11, the first lens 1118 may be secured to an outer portion (e.g., an outer end) of the lens barrel 1112 that extends beyond the lens mount 1110. That is, the first lens 1118 may be secured to an end of the lens barrel 1112 via the lens ring 1120 (e.g., via threading or other mechanical engagement) such that the first lens 1118 may be positioned outboard with respect to the lens mount 1110 and the second lens 1122 along the optical axis 1116. Additionally, the second lens 1122 may be disposed within the lens barrel 1112 such that the second lens 1122 may be positioned between the first lens 1118 and the image sensor 1114. The first lens 1118, the second lens 1122, and the image sensor 1114 may be axially aligned along the optical axis 1116. As a result, the image sensor 1114 may accurately capture images through the first lens 1118 and the second lens 1122 free of distortion and/or obstruction that may be caused by the first lens 1118 and/or the second lens 1122.

The image sensor assembly 1108 may include a sensor housing 1124. The sensor housing 1124 may be similar to the sensor housing 748 of the image sensor assembly 736 shown in FIGS. 7-9. For example, the sensor housing 1124 may define a cavity 1126 therein, and the image sensor 1114 may be located in the cavity 1126 and secured to the PCBA 1106. The sensor housing 1124 may further define an opening 1128, which may be covered or otherwise enclosed by a sensor glass 1130 of the image sensor assembly 1108. The sensor glass 1130 may be transparent such that the image sensor 1114 may capture images through the sensor glass 1130 without obstruction.

As discussed above, the lens mount 1110 may be secured to the PCBA 1106. In particular, the lens mount 1110 may include one or more flanges, such as the lens mount flange 1132 shown in FIG. 11. The lens mount flange 1132 may be inwardly turned such that the lens mount flange 1132 projects (e.g., extend) inwardly toward the optical axis 1116 of the image capture device 1104. The lens mount flange 1132 may provide a greater surface area of the lens mount 1110 when compared to a general wall thickness of the lens mount 1110 extending toward the lens barrel 1112, as illustrated by the thickness (T) shown in FIG. 11. For example, the lens mount flange 1132 may extend around substantially all or an entirety of the circumference of the lens mount 1110 to increase the overall surface area of the lens mount 1110 that contacts the PCBA 1106.

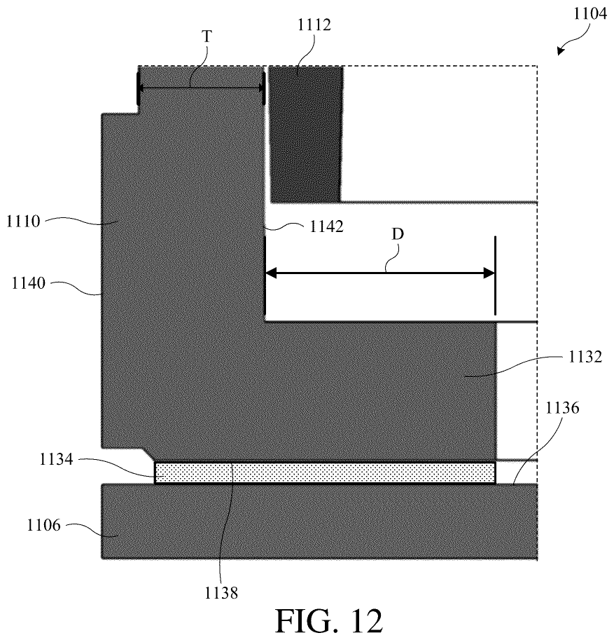

To further illustrate coupling of the lens mount 1110 to the PCBA 1106, FIG. 12 illustrates close-up view 12 of the image capture device 1104 of FIG. 11. The lens mount 1110 may be coupled to the PCBA 1106 by one or more fasteners (e.g., screws, bolts, nails, etc.), one or more mechanical interlocks (e.g., keying mechanism, joint, press-fit, etc.), or both. Additionally, or alternatively, the lens mount 1110 may be coupled to the PCBA 1106 via an adhesive, such as the adhesive 1134.

For example, the adhesive 1134 may be disposed on a surface 1136 (e.g., a top surface) of the PCBA 606 so that the adhesive 1134 may adhere a mating surface 1138 of the lens mount 1110 to the surface 1136 of the PCBA 606. The mating surface 1138 of the lens mount 1110 may be at least partially defined by the lens mount flange 1132. That is, due to the lens mount flange 1132 extending inwardly toward the optical axis 1116, a surface area of the mating surface 1138 may be increased when compared a surface area of the mating surface 1138 that would be defined only by the thickness (T) of the wall of the lens mount 1110, as measured between an outer peripheral surface 1140 and an inner peripheral surface 1142 of the lens mount 1110. As a result, the lens mount flange 1132—and thus the mating surface 1138—may provide the adhesive 1134 a greater surface area in which to bond the lens mount 1110 to the PCBA 606. Moreover, since the lens mount flange 1132 is inwardly turned and projects toward the optical axis 1116, an overall diameter of the lens mount 1110 may be defined by the outer peripheral surface 1140 of the lens mount 1110. That is, the lens mount flange 1132 may not extend outward (e.g., away from the optical axis 1116) beyond the outer peripheral surface 1140 of the lens mount 1110, and thus the lens mount flange 1132 may not increase the overall diameter of the lens mount 1110.

The lens mount flange 1132 may extend inwardly towards the optical axis 1116 any desired distance (D) from the inner peripheral surface 1142 of the lens mount 1110. As such, the overall surface area of the mating surface 1138 may be increased or decreased based upon packaging constraints of the image capture device 1104. Furthermore, the distance (D) of the lens mount flange 1132 may be modified to accommodate packaging the image sensor assembly 1108 within the lens mount 1110, thereby improving the tunability of the lens mount 1110.

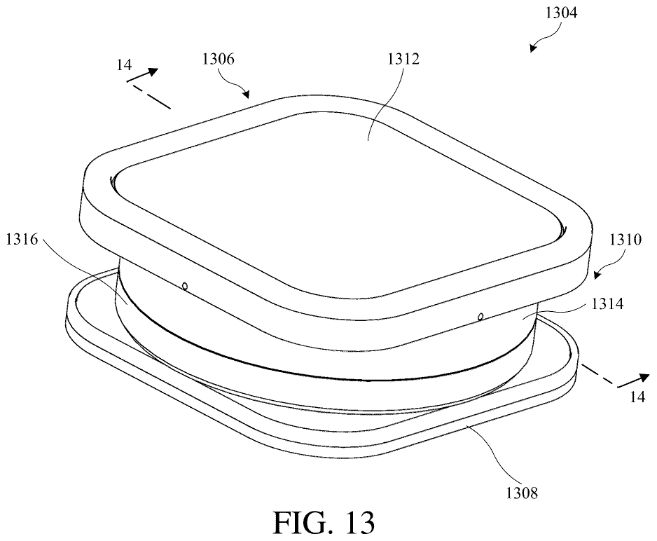

FIG. 13 illustrates an isometric view of another example of an image capture device 1304. Portions of the image capture device 1304 have been removed for clarity. For example, a lens barrel and a lens mount of the image capture device 1304 are intentionally omitted for illustrative purposes. The lens barrel and the lens mount may be similar to those found in the image capture device 604 of FIG. 6 or the image capture device 1104 of FIG. 11.

The image capture device 1304 may include a removable lens cover 1306. The removable lens cover 1306 may be coupled to any portion of the image capture device 1304 and/or any portion of an image capture apparatus that receives the image capture device 1304 (e.g., a body or housing of the image capture apparatus). In an example, the removable lens cover 1306 may be coupled to a lens mount and/or a lens barrel of the image capture device 1304 and/or may be coupled to the housing of the image capture apparatus. For example, the removable lens cover 1306 may be secured to the image capture device 1304 by a mounting plate 1308, which may be coupled (e.g., fixedly or removably) to the lens mount and/or the lens barrel of the image capture device 1304.

Connection of the removable lens cover 1306 to the image capture device 1304 and/or the image capture apparatus may be done in any manner that facilitates easy connection and disconnection of the removable lens cover 1306. As a result, the removable lens cover 1306 may be easily replaceable and/or interchangeable without requiring disassembly of the image capture device 1304.

For example, the mounting plate 1308 may include or may be fixedly connected to a bayonet. As such, the mounting plate 1308 may fixedly secure the bayonet to the image capture device 1304 so that the removable lens cover 1306 may be removably connected to the image capture device 1304 via the bayonet. To facilitate such removable connection, the removable lens cover 1306 may include a frame 1310. The frame 1310 may secure a cover glass 1312 of the removable lens cover 1306 and may also removably couple the removable lens cover 1306 to the mounting plate 1308, and thus also to the image capture device 1304. As discussed further below, the frame 1310 may include a first portion 1314 and a second portion 1316, which may be fixed to one another. In some configurations, the frame 1310 may be a single piece (e.g., only the first portion 1314 or only the second portion 1316). As such, the frame 1310 may removably couple the removable lens cover 1306 to the image capture device 1304 via the mounting plate 1308 (e.g., via the bayonet secured to the mounting plate 1308) so that the cover glass 1312 may protect the lens barrel of the image capture device 1304, including one or more lens of the lens barrel.

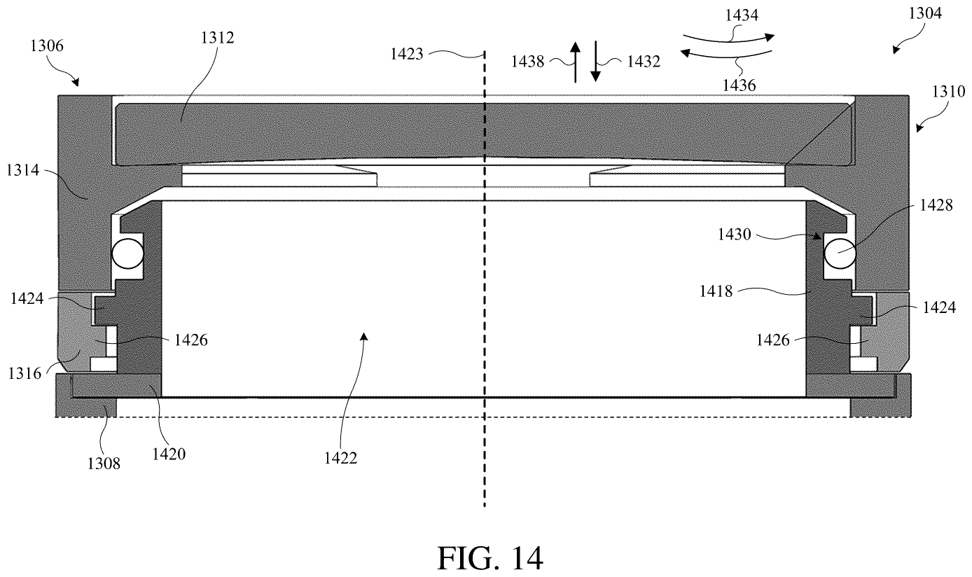

FIG. 14 illustrates a cross-sectional view of the image capture device 1304 shown in FIG. 13 taken along line 14-14. As discussed above, the removable lens cover 1306 may be removably secured to the image capture device 1304 (e.g., the lens barrel and/or the lens mount of the image capture device 1304) via the mounting plate 1308. For example, a bayonet 1418 may be fixedly secured (e.g., mechanically fastened, adhered, etc.) to the mounting plate 1308, such as via a mounting portion 1420. The mounting portion 1420 may be part of the bayonet 1418 or may be coupled to the bayonet 1418 to provide a mating portion between the bayonet 1418 and the mounting plate 1308. As such, the bayonet 1418 may align the removable lens cover 1306 with the mounting plate and/or the lens barrel of the image capture device 1304. In an example, the bayonet 1418 may define a channel 1422 therein, and the lens barrel of the image capture device 1304 may be at least partially located within the channel 1422. Thus, when the removable lens cover 1306 is coupled to the bayonet 1418, the removable lens cover 1306, including the cover glass 1312, may be axially aligned with the lens barrel along an optical axis 1423 of the image capture device 1304.

The bayonet 1418 may include one or more fingers, such as the fingers 1424, which may project away from the bayonet 1418 towards the frame 1310 of the removable lens cover 1306. The fingers 1424 may be positioned anywhere along an outer surface of the bayonet 1418 such that the fingers 1424 may engage a portion of the frame 1310. For example, the fingers 1424 may be configured to engage (e.g., contact, secure, etc.) one or more projections of the second portion 1316 of the frame 1310, such as the projections 1426. As such, each of the fingers 1424 of the bayonet 1418 may engage a respective one of the projections 1426 of the frame 1310. Furthermore, to prevent moisture and/or debris from penetrating a gap between the bayonet 1418 and the frame 1310, a seal 1428 (e.g., a gasket, o-ring, compressible member, etc.) may be disposed in a groove 1430 defined by the bayonet 1418 to seal a gap between the bayonet 1418 and the frame 1310.

An illustrative example of connection and disconnection of the removable lens cover 1306 to the bayonet 1418 will now be discussed in further detail. However, connection and disconnection of the removable lens cover 1306 is not particularly limited to any one technique. As shown in FIG. 14, the removable lens cover 1306 may be aligned with the bayonet 1418 along the optical axis 1423 and moved toward the mounting plate 1308 in a direction 1432. Gaps along the outer surface of the bayonet 1418 may exist between the fingers 1424 so that the projections 1426 of the second portion 1316 of the frame 1310, which may also include gaps therebetween, may be inserted into the gaps between the fingers 1424. The gaps between the fingers 1424 and the gaps between the projections 1426 may be similar to those described in U.S. patent application Ser. No. 18/224,728, filed on Jul. 21, 2023, the entire contents of which are incorporated herein for all purposes. As such, the projections 1426 may be positioned inward from the fingers 1424 of the bayonet 1418 and located between the fingers 1424 and the mounting plate 1308.

Once the projections 1426 are positioned beneath the bayonet 1418 (e.g., closer to the mounting plate 1308), the removable lens cover 1306 may be rotated in a direction 1434 so that the projections 1426 are positioned adjacent to and are contacting the fingers 1424. As such, the removable lens cover 1306 may be secured in place by the bayonet 1418. Conversely, to remove the removable lens cover 1306, the removable lens cover 1506 may be rotated in an opposing direction 1436 to align the projections 1426 with the gaps between the fingers 1424, at which point the removable lens cover 1306 may be moved away from the bayonet 1418 in an opposing direction 1438. Thus, the bayonet 1418 may be substantially or entirely contained within the removable lens cover 1306 when the removable lens cover 1306 is coupled to the bayonet 1418. As such, an outer diameter of the removable lens cover 1306 may be minimized by utilizing an interior region (e.g., the channel 1422) of the removable lens cover 1306 to removably couple the removable lens cover 1306 to the bayonet 1418.

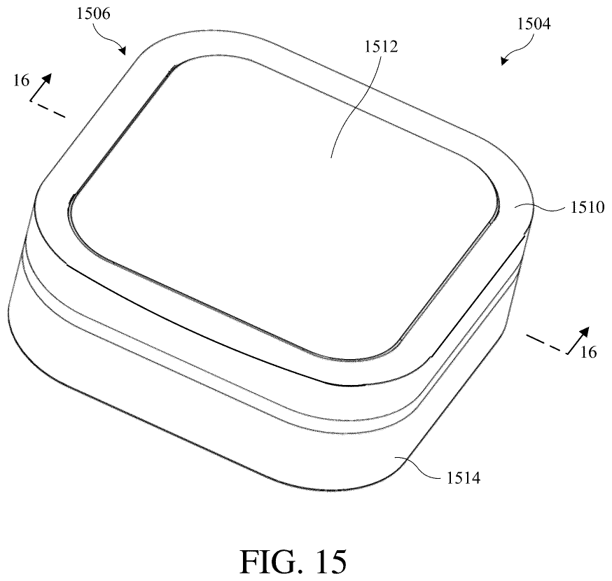

FIG. 15 illustrates an isometric view of another example of an image capture device 1504. Portions of the image capture device 1504 have been removed for clarity. For example, a lens barrel and a lens mount of the image capture device 1504 are intentionally omitted for illustrative purposes. The lens barrel and the lens mount may be similar to those found in the image capture device 604 of FIG. 6 or the image capture device 1104 of FIG. 11. The image capture device 1504 may be similar to the image capture device 1304 of FIGS. 13 and 14.

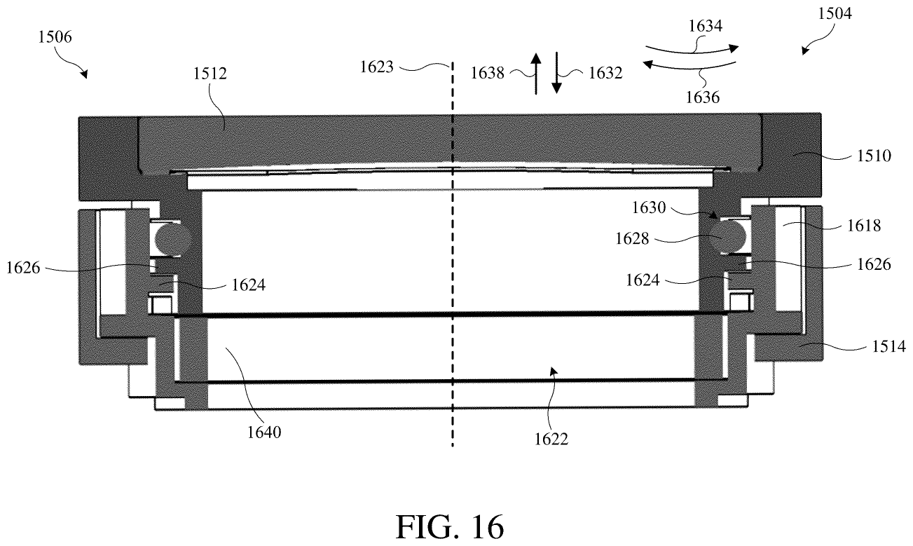

The image capture device 1504 may include a removable lens cover 1506. The removable lens cover 1506 may be coupled to any portion of the image capture device 1504 and/or any portion of an image capture apparatus that receives the image capture device 1504 (e.g., a body or housing of the image capture apparatus). In an example, the removable lens cover 1506 may be coupled to a lens mount and/or a lens barrel of the image capture device 1504 and/or may be coupled to the housing of the image capture apparatus. For example, the removable lens cover 1506 may be secured to the image capture device 1504 by a bayonet (see FIG. 16), which may be coupled (e.g., fixedly or removably) to the lens mount and/or the lens barrel of the image capture device 1504.

Connection of the removable lens cover 1506 to the image capture device 1504 and/or the image capture apparatus may be done in any manner that facilitates easy connection and disconnection of the removable lens cover 1506. As a result, the removable lens cover 1506 may be easily replaceable and/or interchangeable without requiring disassembly of the image capture device 1504.

To facilitate such removable connection, the removable lens cover 1506 may include a frame 1510. The frame 1510 may secure a cover glass 1512 of the removable lens cover 1506 and may also removably couple the removable lens cover 1306 to a bayonet, thereby removably coupling the removable lens cover 1306 to the image capture device 1504. As such, the frame 1510 may removably couple the removable lens cover 1306 to the image capture device 1304 so that the cover glass 1512 may protect the lens barrel of the image capture device 1504, including one or more lens of the lens barrel.

The image capture device 1504 may further include a bayonet housing 1514. The bayonet housing 1514 may extend at least partially around the frame 1510 of the removable lens cover 1506 to contain at least a portion of the frame 1510 therein. As such, the bayonet housing 1514 may act as a protective casing for at least the portion of the frame 1510 therein. Similarly, the bayonet housing 1514 may protect a bayonet of the image capture device 1504 (see FIG. 16). For example, the bayonet housing 1514 may contain the bayonet of the image capture device 1504 and may be secured to a portion of the bayonet, such as via fasteners or an adhesive. As such, an outer surface of the bayonet housing 1514 may substantially align with an outer surface of a portion of the frame when the removable lens cover 1506 is coupled to the bayonet, thereby providing a more planar overall outer surface.

FIG. 16 illustrates a cross-sectional view of the image capture device 1504 shown in FIG. 15 taken along line 16-16. As discussed above, the removable lens cover 1506 may be removably secured to the image capture device 1504 (e.g., the lens barrel and/or the lens mount of the image capture device 1504). For example, a bayonet 1618 may be fixedly secured (e.g., mechanically fastened, adhered, etc.) to a portion of the image capture device 1504 (e.g., the lens barrel, the lens mount) and/or a portion of the image capture apparatus (e.g., a housing of the image capture apparatus). The bayonet 1618 may be similar to the bayonet 1418 of FIG. 14 and may provide a mating portion for the removable lens cover 1506. The bayonet 1618 may align the removable lens cover 1506 with the lens barrel of the image capture device 1504. In an example, the bayonet 1618 may define a channel 1622 therein, and the lens barrel of the image capture device 1504 may be at least partially located within the channel 1622. Thus, when the removable lens cover 1506 is coupled to the bayonet 1618, the removable lens cover 1506, including the cover glass 1512, may be axially aligned with the lens barrel along an optical axis 1623 of the image capture device 1504.

As discussed with respect to the bayonet 1418 of FIG. 14, the bayonet 1618 may include one or more fingers, such as the fingers 1624, which may project inwardly from the bayonet 1618 toward the optical axis 1623. The fingers 1624 may be positioned anywhere along an inner surface of the bayonet 1618 such that the fingers 1624 may engage a portion of the frame 1510. For example, the fingers 1624 may be configured to engage (e.g., contact, secure, etc.) one or more projections of the frame 1510, such as the projections 1626. As such, each of the fingers 1624 of the bayonet 1618 may engage a respective one of the projections 1626 of the frame 1510. Furthermore, to prevent moisture and/or debris from penetrating a gap between the bayonet 1618 and the frame 1510, a seal 1628 (e.g., a gasket, o-ring, compressible member, etc.) may be disposed in a groove 1630 defined by the frame 1510 to seal a gap between the bayonet 1618 and the frame 1510.

As shown in FIG. 16, to connect the removable lens cover 1506 to the bayonet 1618, the removable lens cover 1506 may first be aligned with the bayonet 1618 along the optical axis 1623 and moved toward bayonet 1618 in a direction 1632 at least partially into the channel 1622. Gaps along the inner surface of the bayonet 1618 may exist between the fingers 1624 so that the projections 1626 of the frame 1510, which may also include gaps therebetween, may be inserted into the gaps between the fingers 1624. As such, the projections 1626 may be positioned inward from the fingers 1624 of the bayonet 1618 and located between the fingers 1624 and a spacer 1640, whereby the spacer 1640 may be disposed within the channel 1622 and may abut an edge of the frame 1510 to at least partially support the frame 1510 and/or maintain a position of the frame 1510.

Once the projections 1626 are positioned beneath the bayonet 1618 (e.g., closer to the spacer 1640), the removable lens cover 1506 may be rotated in a direction 1634 so that the projections 1626 are positioned adjacent to and are contacting the fingers 1624. As such, the removable lens cover 1506 may be secured in place by the bayonet 1618. Conversely, to remove the removable lens cover 1506, the removable lens cover 1506 may be rotated in an opposing direction 1636 to align the projections 1626 with the gaps between the fingers 1624, at which point the removable lens cover 1506 may be moved away from the bayonet 1618 in an opposing direction 1638. Thus, the frame 1510 may be substantially or entirely constrained within the bayonet 1618 when the removable lens cover 1506 is coupled to the bayonet 1618. As such, an outer diameter of the removable lens cover 1506 may be minimized by utilizing an interior region (e.g., the channel 1622) of the bayonet 1618 to removably couple the removable lens cover 1506 to the bayonet 1618.

The methods and techniques of the image sensor stiffener, lens mount, and removable lens cover described herein, or aspects thereof, may be implemented by an image capture apparatus, or one or more components thereof, such as the image capture apparatus 100 shown in FIGS. 1A-1B, the image capture apparatus 200 shown in FIGS. 2A-2B, the image capture apparatus 300 shown in FIG. 3, the image capture apparatus 400 shown in FIGS. 4A-4B, or the image capture apparatus 500 shown in FIG. 5. The methods and techniques of the image sensor stiffener, lens mount, and removable lens cover described herein, or aspects thereof, may be implemented by an image capture device, such as the image capture device 104 shown in FIGS. 1A-1B, one or more of the image capture devices 204, 206 shown in FIGS. 2A-2B, one or more of the image capture devices 304, 306 shown in FIG. 3, the image capture device 404 shown in FIGS. 4A-4B, an image capture device of the image capture apparatus 500 shown in FIG. 5, the image capture device 604 shown in FIGS. 6-9, the image capture device 1104 shown in FIGS. 11-12, the image capture device 1304 shown in FIGS. 13-14, or the image capture device 1504 shown in FIGS. 15-16.

While the disclosure has been described in connection with certain embodiments, it is to be understood that the disclosure is not to be limited to the disclosed embodiments but, on the contrary, is intended to cover various modifications and equivalent arrangements included within the scope of the appended claims, which scope is to be accorded the broadest interpretation so as to encompass all such modifications and equivalent structures as is permitted under the law.

What is claimed is:

1. An image capture apparatus, comprising:
a housing defining a cavity therein;
an image capture device extending through the housing and at least partially disposed in the cavity of the housing, wherein the image capture device includes:
a printed circuit board assembly;
a stiffener coupled to the printed circuit board assembly, wherein the stiffener is configured to prevent warpage of the printed circuit board assembly; and
an image sensor coupled to the stiffener.

2. The image capture apparatus of claim 1, wherein the image sensor and the printed circuit board assembly are free of direct contact.

3. The image capture apparatus of claim 1, wherein the image sensor and the printed circuit board assembly are in electrical communication with each other through the stiffener.

4. The image capture apparatus of claim 3, wherein the stiffener defines a slot and wiring extends through the slot between an electrical contact of the image sensor and an electrical contact of the printed circuit board assembly.

5. The image capture apparatus of claim 1, wherein the stiffener is located between the printed circuit board assembly and the image sensor, and wherein the image sensor is positioned outboard with respect to printed circuit board assembly toward an exterior of the housing and along an optical axis of the image capture device.

6. The image capture apparatus of claim 1, wherein the image capture device further includes a sensor housing that is coupled to the stiffener, and wherein the image sensor is disposed within a cavity defined by the sensor housing.

7. The image capture apparatus of claim 6, wherein the sensor housing defines an opening, and wherein a sensor glass is disposed over the opening such that a field of view of the image sensor remains unobstructed by the sensor housing.

8. The image capture apparatus of claim 1, wherein an outer perimeter of the stiffener is contained within an outer perimeter of the printed circuit board assembly.

9. The image capture apparatus of claim 1, wherein the image capture device further includes:
a lens mount coupled to a surface of the printed circuit board assembly; and
a lens barrel at least partially disposed within and coupled to the lens mount.

10. The image capture apparatus of claim 9, wherein the lens barrel and the image sensor are aligned along an optical axis of the image capture device.

11. The image capture apparatus of claim 1, wherein the stiffener is coupled to a first surface of the printed circuit board assembly, and wherein the image capture device further includes a shield coupled to an opposing second surface of the printed circuit board assembly.

12. An image capture apparatus, comprising:
a housing defining a cavity therein;
an image capture device that includes:
a printed circuit board assembly located within the cavity of the housing;
an image sensor assembly that includes:
a stiffener coupled to a surface of the printed circuit board assembly;
a sensor housing coupled to a surface of the stiffener; and
an image sensor located within the sensor housing and coupled to the surface of the stiffener, wherein the image sensor is in electrical communication with the printed circuit board assembly through the stiffener.

13. The image capture apparatus of claim 12, wherein the stiffener defines a slot, and wherein wiring extends through the slot between the image sensor and the printed circuit board assembly to establish electrical communication therebetween.

14. The image capture apparatus of claim 12, wherein the stiffener is configured to prevent warpage of the printed circuit board assembly that is caused by moisture or heat.

15. The image capture apparatus of claim 12, wherein the image capture device further includes a lens barrel that is indirectly coupled to the stiffener and axially aligned with the image sensor along an optical axis of the image capture device.

16. The image capture apparatus of claim 15, wherein the lens barrel is at least partially disposed within a lens mount, and wherein the lens mount is coupled to the surface of the stiffener.

17. An image capture device, comprising:
a printed circuit board assembly;
an image sensor assembly that includes:
a stiffener coupled to a surface of the printed circuit board assembly;
a sensor housing coupled to a surface of the stiffener; and
an image sensor located within the sensor housing and coupled to the surface of the stiffener;
a lens mount coupled to the surface of the printed circuit board assembly; and
a lens barrel at least partially disposed within and coupled to the lens mount, wherein the lens barrel and the image sensor are axially aligned along an optical axis of the image capture device.

18. The image capture device of claim 17, wherein the stiffener is configured to prevent warpage of the printed circuit board assembly, and wherein the image sensor is in electrical communication with the printed circuit board assembly through the stiffener.

19. The image capture device of claim 17, further comprising one or more lenses disposed within the lens barrel, wherein the one or more lenses are axially aligned with the image sensor along the optical axis.

20. The image capture device of claim 17, wherein the image sensor assembly is contained within the lens mount.
